(19) United States
(12) Patent Application Publication
(10) Pub. No.: US 2018/0105661 A1
(43) Pub. Date: Apr. 19, 2018

(54) OXAZOLINE ANTI-CONDENSATION COMPOSITIONS, LAMINATES, AND PROCESSES FOR MAKING THE SAME

(71) Applicant: CELANESE INTERNATIONAL CORPORATION, IRVING, TX (US)

(72) Inventors: Michael COMBS, Pembroke, VA (US); Rafael Rongfu LI, Blacksburg, VA (US); Xiaowei ZHANG, Union, KY (US); Kevin PARKER, Hilton Derby (GB); Joanna MARSHALL, Lichfield Staffordshire (GB); Stephen BERNARD, Derby (GB)

(21) Appl. No.: 15/786,143

(22) Filed: Oct. 17, 2017

Related U.S. Application Data
(60) Provisional application No. 62/409,141, filed on Oct. 17, 2016.

(51) Int. Cl. C08J 5/18; C08G 73/02; C08L 1/12; C08L 1/26; C08K 5/00; C08K 5/053; C08K 5/13; B32B 23/08; B32B 23/20; B32B 23/22

(52) U.S. Cl. CPC C08J 5/18; C08G 73/0233; C08L 1/12; C08L 1/26; C08K 5/0016; C08K 5/053; B32B 2307/54; B32B 23/08; B32B 23/20; B32B 23/22; C08G 2290/00; C08L 2203/16; B32B 2250/40; C08K 5/13

(57) ABSTRACT

Anti-condensation compositions and laminates comprising a cellulosic material selected from a cellulose ester and a cellulose ether and a polymer of an oxazoline, and processes for making such anti-condensation compositions without the need for saponification. Such compositions have now been shown to exhibit extremely desirable anti-condensation characteristics, with a low degree of hazing and increased hardness.

### CROSS REFERENCE TO RELATED APPLICATION

This application claims priority to U.S. Provisional Application No. 62/409,141, filed on Oct. 17, 2016, the entirety of which is incorporated herein by reference.

### FIELD OF THE INVENTION

The present disclosure relates generally to anti-condensation compositions, laminates, and processes for making anti-condensation compositions. In particular, the present disclosure relates to anti-condensation compositions comprising a cellulosic material and a polymer of an oxazoline.

### BACKGROUND OF THE INVENTION

Anti-condensation compositions, such as coatings and films, are often utilized with many substrates to provide beneficial characteristics and/or properties to the substrate. As one example, conventional condensation resistant films (e.g., anti-fog films) may be applied to glass or mirrored surfaces to prevent the formation of water droplets thereon.

Many conventional fog resistant films comprise multiple laminated layers, e.g., a polycarbonate or polyester layer with a polyurethane or silane coating. These layers may be formulated so that the layers adhere to one another. In use, however, these layers may separate from one another, creating performance and/or durability problems.

Other conventional fog resistant films utilize a one-piece configuration. These fog resistant films may comprise a cellulose ester portion and a condensation resistant region. The fog resistant film may be formed by treating a cellulose acetate film with an alkali solution. Japanese Patent Application No. 2013099879A and International Publication No. 2008/029801A1, both of which are incorporated herein by reference, disclose such fog resistant films and methods for preparing such films. These fog resistant films, however, may suffer from insufficient fog resistance and/or a lack of film transparency, e.g., haziness.

Another anti-fog composition, described in U.S. Patent Publication No. 2015/0079381, incorporated herein by reference in its entirety, comprises a primary film having opposing major planar surfaces and a central coplanar region disposed between the opposing major planar surfaces. The primary film comprises cellulose acetate, plasticizer and an anti-blocking agent. The composition is formed by saponifying a precursor film to improve hydrophilicity.

U.S. Patent Publication No. 2016/0053152, which is also incorporated herein by reference in its entirety, describes an anti-fog consumer product formed by a process comprising the steps of forming a precursor composition comprising cellulose acetate and a plasticizer to yield a substantially rigid consumer product having an outer surface, and saponifying at least a portion of the substantially rigid consumer product to yield the anti-fog consumer product having a degree of substitution at the outer surface of less than 0.75.

The need exists for an anti-condensation composition having desirable anti-condensation characteristics and/or improved clarity, e.g., reduced haziness. In addition, the need exists for anti-condensation compositions that may be formed without the need for saponification. The need also exists for highly durable anti-condensation compositions, e.g., films, laminates, and coatings.

### SUMMARY OF THE INVENTION

In some embodiments, the present disclosure relates to an anti-condensation composition, comprising a cellulosic material selected from cellulose, a cellulose ester, a cellulose ether, an ether cellulose ester, nitrocellulose and mixtures thereof, a polymer of an oxazoline having an average molecular weight greater than 50,000 daltons, and optionally a plasticizer.

In some embodiments, the present disclosure relates to an anti-condensation composition, consisting essentially of a cellulosic material selected from cellulose, a cellulose ester, a cellulose ether, an ether cellulose ester, nitrocellulose and mixtures thereof, a polymer of an oxazoline, optionally a surfactant, optionally a plasticizer, optionally a lubricant, optionally a crosslinking agent, optionally a coloring agent, and optionally a hydrophilic agent. The composition is free of active ingredients such as a pharmaceutical compositions.

In some embodiments, the present disclosure relates to an anti-condensation composition, comprising a cellulosic material selected from cellulose, a cellulose ester, a cellulose ether, an ether cellulose ester, nitrocellulose and mixtures thereof, a polymer of an oxazoline, a surfactant and optionally a plasticizer.

In some embodiments, the polymer of the oxazoline optionally comprises poly(2-ethyl-2-oxazoline). In some aspects, the oxazoline has a structure of formula (I):

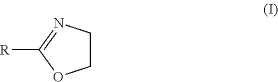

wherein R is hydrogen, an alkyl group, a carboxyl group, a hydroxyl group or an ether group. The polymer is optionally soluble in acetone, and optionally has a molecular weight from 60,000 to 1,000,000 daltons, e.g., from 100,000 to 1,000,000 daltons, from 200,000 to 1,000,000 daltons, from 200,000 to 800,000 daltons, from 400,000 to 600,000 daltons or from 60,000 to 600,000 daltons. In some aspects, the composition comprises the polymer in an amount from 2 to 40 wt. %, e.g., from 18 to 28 wt. %, based on the total weight of the composition.

If the composition comprises a plasticizer, the plasticizer is optionally selected, for example, from the group consisting of 1,2,3-triacetoxypropane (triacetin), trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methyl pyrollidinone, C₁-C₂₀ diacid esters, dimethyl adipate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, and mixtures thereof. In some aspects, the plasticizer is selected from the group consisting of ethylene carbonate, propylene carbonate, and trimethylene carbonate. The plasticizer is optionally present in an amount from 3 to 30 wt. %, based on the total weight of the composition.

In some aspects, the polymer may have a molecular weight from 200,000 to 1,000,000 daltons, and the composition may comprise the polymer in an amount from 2 to 40 wt. %, based on the total weight of the composition. In other aspects, the polymer may have a molecular weight from 60,000 to 600,000 daltons, and the composition may comprise the polymer in an amount from 18 to 28 wt. %, based on the total weight of the composition.

In other aspects, the anti-condensation composition comprises the polymer in an amount from 18 to 28 wt. %, based on the total weight of the composition, wherein the polymer has a molecular weight from 400,000 to 600,000 daltons, and the composition has a condensation time ranging from 30 to 90 seconds and a haze value less than 1%. In some aspects, the anti-condensation composition comprises the polymer in an amount from 28 to 34 wt. %, a surfactant in an amount from 0 to 2 wt %, and a plasticizer in an amount from 0 to 5 wt %, based on the total weight of the composition, wherein the condensation time is greater than or equal to 2 minutes. In some aspects, the anti-condensation composition comprises the polymer in an amount from 28 to 33 wt. %, a surfactant in an amount from 1 to 1.5 wt %, and a plasticizer in an amount from 4 to 5 wt %, wherein the condensation time is greater than 5 minutes.

In some aspects, the anti-condensation composition has a thickness from 13 to 30 microns, wherein the polymer has a molecular weight from 50,000 to 500,000 daltons, and the composition has a condensation time from 55 to 108 seconds. In some aspects, the composition has a thickness from 17 to 30 microns, wherein the polymer has a molecular weight from 50,000 to 200,000 daltons, and the composition has a condensation time from 55 to 108 seconds.

In some aspects, the anti-condensation composition has a thickness from 100 to 300 microns, wherein the composition comprises the polymer in an amount from 18 to 28 wt. % and propylene carbonate in an amount from 5 to 14 wt %, based on the total weight of the composition, wherein the polymer has a molecular weight from 200,000 to 500,000 daltons, wherein a pencil hardness of the composition is from 5B to 2H. The anti-condensation composition may have a tensile strength from 65 Nmm⁻² to 100 Nmm⁻², an elongation from 10% to 50%, and a Young's modulus from 1800 Nmm⁻² to 3500 Nmm⁻². The anti-condensation composition may have a condensation time greater than 90 seconds and a haze value from 0.1% to 0.3%.

In some aspects, the anti-condensation composition has a thickness from 230 to 250 microns, wherein the composition comprises the polymer in an amount from 18 to 23 wt. % and propylene carbonate in an amount from 5 to 14 wt %, based on the total weight of the composition, wherein the polymer has a molecular weight of 400,000 to 600,000 daltons, wherein a pencil hardness of the composition is from H to 2H. The anti-condensation composition has a tensile strength from 67 Nmm⁻² to 82 Nmm⁻², an elongation from 28% to 40%, and a Young's modulus from 2150 Nmm⁻² to 2500 Nmm⁻². The anti-condensation composition may have a condensation time greater than 90 seconds and a haze value ranging from 0.13% to 0.3%.

In some embodiments, the composition further comprises a surfactant in an amount from 0.1 to 3 wt. %, based on the total weight of the composition. The surfactant is optionally may be selected from the group consisting of a sorbitan ester, an ethoxylated sorbitan ester, ethoxylate surfactants, fatty alcohol ethoxylates, alkyl phenols ethoxylate, a fluorosurfactant, a nonionic surfactant, an anionic surfactant, and a cationic surfactant. The anti-condensation composition optionally further comprise the surfactant in an amount from 0.1 to 3 wt. %, based on the total weight of the composition.

The cellulosic material may vary widely, but in some aspects comprises cellulose acetate, cellulose acetate propionate, cellulose acetate butyrate, an ether cellulose ester, nitrocellulose, ethyl cellulose or a mixture thereof. The cellulosic material optionally comprises cellulose acetate having a degree of substitution from 1.2 to about 3, e.g., from 2.3 to 2.7.

The anti-condensation compositions optionally exhibit a condensation time, as described herein, greater than 10 seconds and optionally a haze value, as described herein, ranging from 0.01% to 4%.

Although the form of the composition may vary, it optionally has a thickness from 5 microns to 4000 microns. The composition may be a coating or film or a substantially rigid article, and may be saponified or unsaponified. The anti-condensation composition preferably has pencil hardness values greater than F.

In some embodiments, the present disclosure relates to a consumer product having a surface and any of the above described anti-condensation compositions disposed on said surface as a film or coating. For example, the consumer product optionally is selected from the group consisting of lenses, windows, screens, glass structures, containers, appliances, plastic, refrigerating devices, optical devices, and visors.

In some embodiments, the present disclosure relates to a dope, comprising a cellulosic material selected from cellulose, a cellulose ester, a cellulose ether, an ether cellulose ester, nitrocellulose and mixtures thereof, a polymer of an oxazoline having an average molecular weight greater than 50,000 daltons, a solvent, and optionally a plasticizer.

In some embodiments, the present disclosure relates to a process for producing an anti-condensation composition, the process comprising the steps of: (a) combining a solvent, a cellulosic material selected from cellulose, a cellulose ester, a cellulose ether, an ether cellulose ester, nitrocellulose and mixtures thereof, a polymer of an oxazoline having an average molecular weight greater than 50,000 daltons, optionally a plasticizer and optionally a surfactant, to form a dope; and (b) casting the dope to form the anti-condensation composition.

In some embodiments, the present disclosure relates to a process for producing an anti-condensation composition, the process comprising the steps of: (a) combining a solvent, a cellulosic material selected from a cellulose ester, a cellulose ether, an ether cellulose ester, nitrocellulose and mixtures thereof, a polymer of an oxazoline, optionally a plasticizer and optionally a surfactant, to form a dope; (b) removing the solvent to form a polymer block; and (c) planing the block to form the anti-condensation composition.

In other embodiments, the present disclosure relates to a process for producing an anti-condensation composition, the process comprising the steps of: (a) combining a solvent, a cellulosic material selected from a cellulose ester, a cellulose ether, an ether cellulose ester, nitrocellulose and mixtures thereof, a polymer of an oxazoline, optionally a plasticizer and optionally a surfactant, to form a dope; (b) removing the solvent to form a solid polymer composition; and (c) pelletizing the solid polymer composition to form a pelletized polymer composition. The process optionally further comprises the step of: (d) melt extruding the pelletized polymer composition to form the anti-condensation composition.

In each of the processes, the dope optionally comprises the solvent in an amount from 70 to 80 wt. %, the cellulosic material, e.g., cellulose acetate, in an amount from 5 to 15 wt. %, the polymer in an amount from 1 to 10 wt. %, and the plasticizer in an amount from 0.1 to 5 wt. %. The solvent optionally comprises acetone.

In some embodiments, the present disclosure relates to a process for producing an anti-condensation composition, the process comprising the steps of: (a) providing a pelletized polymer composition comprising a cellulosic material selected from a cellulose ester, a cellulose ether, an ether cellulose ester, nitrocellulose and mixtures thereof, a polymer of an oxazoline, optionally a plasticizer and optionally a surfactant; and (b) melt extruding the pelletized polymer composition into a mold to form the anti-condensation composition.

In some embodiments, the present disclosure is directed to a laminate comprising at least one anti-condensation layer comprising a cellulosic material selected from cellulose, a cellulose ester, a cellulose ether, an ether cellulose ester, nitrocellulose and mixtures thereof, a polymer of an oxazoline having an average molecular weight greater than 50,000 daltons, and a plasticizer, and a core layers. In some aspects, the laminate comprises two anti-condensation layers and the core layer is sandwiched between the two anti-condensation layers. In some aspects, the polymer of the anti-condensation layer has a molecular weight from 200,000 to 1,000,000 daltons, and the composition comprises the polymer in an amount from 2 to 40 wt. %, based on the total weight of the composition. The anti-condensation layer may further comprise a surfactant selected from the group consisting of a sorbitan ester, an ethoxylated sorbitan ester, ethoxylate surfactants, fatty alcohol ethoxylates, alkyl phenols ethoxylate, a fluorosurfactant, a nonionic surfactant, an anionic surfactant, an anionic fluorosurfactant, and a cationic surfactant, present in an amount from 0.1 to 3 wt. %, based on the total weight of the composition. In certain aspects, the anti-condensation layer is extruded or coated onto the core layer. In some embodiments, the core layer may comprise a plurality of layers laminated together.

In some embodiments, the anti-condensation composition comprises the polymer in an amount from 10 to 40 wt. %, based on the total weight of the anti-condensation composition, wherein the polymer has a molecular weight from 200,000 to 800,000 daltons, and the anti-condensation composition has a condensation time greater than 10 seconds and a haze value ranging from 0.01% to 4%.

In some embodiments, the core layer comprises cellulose acetate and a plasticizer, wherein the plasticizer comprises a low water-solubility plasticizer. The low water-solubility plasticizer may be selected from, for example, the group consisting of phosphate plasticizers, acetyl trimethyl cictrate, acetyl triethyl citrate, acetyl tributyl citrate, dimethyl sebacate, di-n-butyl sebacate, dioctyl sebacate, diisodecyl adipate, dibutoxylethyl adipate, dibutoxyethoxylethyl sebacate, dibutyl phthalate, diaryl phthalate, dethyl phthalate, di-octyl phthalate (and isomers), di-n-heptyl phthalate, di-2-ethylhexyl phthalate, diisononyl phthalate, diisodecyl phthalate, diundecyl phthalate, tri-2-ethylhexyl trimellitate, tri-(7C-9C(linear)) trimellitate, dibutyl tartrate, polyethylene glycol diesters, epoxidized soy bean oil, castor oil, linseed oil, expoxidized linseed oil, other vegetable oils, polymeric polyester plasticizers, and combinations thereof.

In some embodiments, the plasticizer may comprise a phosphate plasticizer selected from the group consisting of tris(chloroisopropyl)phosphate, trimethyl phosphate, triethyl phosphate, tributyl phosphate, triphenyl phosphate, tri cresyl phosphate (such as Trade name TCP-100, TCP-40), tris(dichloropropyl) phosphate, tri-(2-ethylhexyl) phosphate, triisopropyl phenyl phosphate, alkyl diaryl phosphates such as 2-ethylhexyl diphenyl phosphate, isodecyl diphenyl phosphate, tributoxyethyl phosphate, butylphenyl diphenyl phosphate, cresyl diphenyl phosphate, isopropylphenyl diphenyl phosphate, diphenyl octyl phosphate, trixylenyl phosphate, and combinations thereof.

In some aspects, the anti-condensation layer comprises the polymer in an amount from 10 to 30 wt. % and cellulose acetate in an amount from 70-90 wt %, based on the total weight of the anti-condensation layer, and the core layer comprises tris(chloroisopropyl)phosphate in an amount from 10 to 20 wt. % and cellulose acetate in an amount from 80 to 90 wt. %, based on the total weight of the core layer. In some aspects, the laminate may have a condensation time greater than 240 seconds.

### DETAILED DESCRIPTION OF THE INVENTION

### Introduction

It has now been discovered that anti-condensation compositions such as films, laminates, coatings or extruded consumer products may be formed without the need for saponification during manufacture. The novel anti-condensation compositions comprise a cellulosic material selected from cellulose, a cellulose ester, a cellulose ether, an ether cellulose ester, nitrocellulose and mixtures thereof and a polymer of an oxazoline, the polymer preferably having an average molecular weight greater than 50,000 daltons. Such compositions have now been shown to exhibit extremely desirable anti-condensation characteristics, a low degree of hazing, and enhanced durability. Eliminating the saponification step results in improved manufacturing efficiency.

### Anti-Condensation Compositions

Although the specific components of the anti-condensation compositions may vary widely, in preferred embodiments, the anti-condensation composition comprises a cellulosic material and a polymer of an oxazoline.

In some embodiments, the anti-condensation composition consists essentially of a cellulosic material selected from cellulose, a cellulose ester, a cellulose ether, an ether cellulose ester, nitrocellulose and mixtures thereof, a polymer of an oxazoline, optionally a surfactant, optionally a plasticizer, optionally a lubricant, optionally a crosslinking agent, optionally a coloring agent, and optionally a hydrophilic agent. The composition is free of active ingredients such as a pharmaceutical compositions.

In other embodiments, the anti-condensation composition comprises a cellulosic material selected from cellulose, a cellulose ester, a cellulose ether, an ether cellulose ester, nitrocellulose and mixtures thereof, a polymer of an oxazoline, a surfactant and optionally a plasticizer.

Cellulose is generally known to be a semi-synthetic polymer containing anhydroglucose repeating units with three hydroxyl groups per anhydroglucose unit. Cellulose acetate may be formed by esterifying cellulose after activating the cellulose with acetic acid. The cellulose may be obtained from any cellulose containing material, such as, for example, from plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification. Combinations of sources are also within the contemplation of the present disclosure.

In exemplary embodiments, the cellulosic material may be selected from cellulose, a cellulose ester, a cellulose ether, an ether cellulose ester, nitrocellulose, including optionally derivatives thereof and mixtures thereof. A non-limiting list of exemplary cellulose esters includes cellulose acetate, cellulose acetate propionate, cellulose acetate butyrate, cellulose acetate phthalate, cellulose acetate succinate, calcium carboxymethyl cellulose, carboxymethyl cellulose acetate butyrate, potassium cellulose succinate, and sodium cellulose succinate. A non-limiting list of exemplary cellulose ethers includes methyl cellulose, ethyl cellulose, propyl cellulose, hydroxymethyl cellulose, hydroxyethyl cellulose, hydroxypropyl cellulose, cellulose gum, methyl ethylcellulose, and various mixtures thereof. A non-limiting list of exemplary cellulose derivatives that include one or more ester and ether components in the same polymer includes carboxymethyl hydroxyethylcellulose, carboxy acetate propionate, cetyl hydroxyethylcellulose, hydrolyzed cellulose gum, hydroxylbutyl methylcellulose, hydroxyethyl ethylcellulose, hydroxypropyl methylcellulose, hydroxypropyl methylcellulose acetate/succinate, methyl hydroxyethylcellulose, and various mixtures thereof. Additionally or alternatively, the anti-condensation composition may comprise a plurality of different cellulose esters (e.g., both cellulose acetate and cellulose butyrate) and/or a plurality of different cellulose ethers and/or blends of cellulose ethers and cellulose esters.

In other embodiments, the cellulosic materials, e.g., cellulose esters and/or cellulose ethers, suitable for use in producing the anti-condensation composition of the present disclosure have substituents that include, but are not limited to, C₁-C₂₀ aliphatic esters or ethers (e.g., acetate, propionate, or butyrate), functional C₁-C₂₀ aliphatic esters or ethers (e.g., succinate, glutarate, maleate), aromatic esters or ethers (e.g., benzoate or phthalate), substituted aromatic esters or ethers, and the like, any derivative thereof, and any combination thereof. Cellulosic materials suitable for use in producing the anti-condensation compositions of the present disclosure may, in some embodiments, have a molecular weight ranging from a lower limit of about 10,000 daltons, 15,000 daltons, 25,000 daltons, 50,000 daltons, or 85,000 daltons to an upper limit of about 125,000 daltons, 100,000 daltons, or 85,000 daltons, and wherein the molecular weight may range from any lower limit to any upper limit and encompass any subset therebetween. In some embodiments, the number average molecular weight of the cellulosic material may range from 40,000 to 100,000 daltons, e.g., from 50,000 to 80,000 daltons or 75,000 to 80,000 daltons. Unless otherwise indicated, all molecular weights disclosed herein are number average molecular weights.

The cellulosic materials used in the production of the anti-condensation composition may comprise cellulose diacetate or cellulose triacetate. In some embodiments, the cellulose acetate comprises or consists essentially of cellulose diacetate. In other embodiments, the cellulosic material is substantially free of cellulose triacetate. As used herein, cellulose acetate refers to cellulose acetate having a degree of substitution from 0.2 to 3, e.g., from 1.2 to 3, or from 2.3 to 2.7. Cellulose acetate having a degree of substitution from 2.3 to 2.7, e.g., 2.4 to 2.5, is referred to herein as cellulose diacetate or as simply “diacetate,” while cellulose acetate having a degree of substitution greater than 2.8, e.g., greater than 2.9, is referred to herein as cellulose triacetate or as “triacetate.”

In other aspects, the cellulosic material comprises a polymer of the following formula:

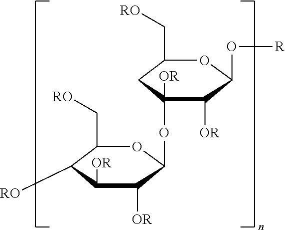

wherein each R is independently selected from hydrogen, acetate, propionate, succinate, butyrate, phthalate, and mixtures thereof, optionally with any of the degrees of substitution discussed above. In other embodiments, each R is independently selected from hydrogen, methyl, ethyl, propyl, hydroxymethyl, hydroxyethyl, hydroxypropyl, and mixtures thereof, optionally with any of the degrees of substitution discussed above. In other embodiments, each R is independently selected from hydrogen, acetate, propionate, succinate, butyrate, phthalate, methyl, ethyl, propyl, hydroxymethyl, hydroxyethyl, hydroxypropyl, and mixtures thereof, optionally with any of the degrees of substitution discussed above. In other embodiments, R is a nitro group.

Cellulose acetate has an acetyl value, which is a measure of the degree of substitution of the cellulose acetate. The acetyl value represents the weight percent of acetic acid liberated by the saponification of cellulose triacetate to form the cellulose acetate having the desired degree of substitution during manufacture of the cellulose acetate. It should be noted that, in this context, by eliminating the need for a saponification step according to preferred embodiments of the present disclosure, it is meant that the anti-condensation compositions, e.g., films, laminates, coatings or consumer products, formed are not saponified in order to impart anti-condensation characteristics; notwithstanding that the cellulosic material may have been subjected to a prior saponification step in order to provide the desired acetyl value for the cellulosic material before being dissolved in a solvent to form a dope, as described in greater detail below.

The acetyl value and degree of substitution are linearly related. The degree of substitution may be calculated from the acetyl value according to the following formula:

$$Degree of substitution = \frac{Acetyl value \times 162}{6005 - ( Acetyl value \times 42 )}$$

In the production of the anti-condensation composition, one or more solvents, e.g., acetone, may be used to dissolve the cellulosic material and the polymer of the oxazoline. The solubility of the cellulosic material, e.g., cellulose acetate, in a solvent depends, at least in part, on the acetyl value of the cellulosic material. As the acetyl value decreases, solubility may improve in ketones, esters, nitrogen-containing compounds, glycols and ethers. As the acetyl value increases, solubility of the cellulosic material may improve in halogenated hydrocarbons. As a result, the acetyl value and degree of substitution of the cellulosic material employed may impact the ability to form durable and mechanically uniform anti-condensation compositions.

The cellulosic material, e.g., cellulose acetate, may be initially provided in any form, e.g., flake, powder or tow form, so long as it is capable of being dissolved along with the polymer of the oxazoline in a solvent to form a dope. The flake form may have an average flake size from 5 μm to 10 mm, as determined by sieve analysis. The flake preferably has low moisture content, optionally comprising less than 6 wt % water, e.g., less than 5 wt % water or less than 2.5 wt % water. In terms of ranges, the flake form may have from 0.01 to 6 wt % water, e.g., from 0.1 to 2.5 wt % water or from 0.5 to 2.45 wt % water. Prior to mixing, the flake may be heated to remove moisture. In some embodiments, the flake may be dried until it has a water content of less than 2 wt. %, e.g., less than 1.5 wt. %, less than 1 wt. % or less than 0.2 wt. %, The drying may be conducted at a temperature from 30 to 100° C., e.g., from 50 to 80° C., and for a period of 1 to 24 hours, e.g., from 5 to 20 hours or from 10 to 15 hours.

In preferred embodiments, the cellulosic material comprises a cellulose ester, specifically, cellulose acetate. In this context, the term “cellulose acetate” refers to cellulose acetate compositions having varying degrees of substitution so long as, on average, the glucose monomers in the cellulosic material are substituted with at least one acetyl moiety, preferably at least two acetyl moieties. Thus, the degree of substitution of the cellulose acetate may vary widely, which may, in turn, impact the hydrophilicity of the anti-condensation composition, with lower degrees of substitution corresponding to increased hydrophilicity. In some aspects, for example, the cellulosic material comprises cellulose acetate having a degree of substitution ranging greater than 2, e.g., greater than 2.3, or greater than 2.5. In terms of ranges, the degree of substitution optionally ranges from 1.2 to 3, from 2.3 to 2.7, or from 2.4 to 2.6.

The aforementioned degrees of substitution also apply to cellulosic materials other than cellulose acetate as contemplated by the present disclosure, e.g., mixed esters such as cellulose acetate propionate (meaning cellulose polymers having both acetate and propionate groups, randomly substituted along the cellulose chain), and cellulose ethers, such as methyl cellulose, as well as mixed ether/esters of cellulose, e.g., methyl cellulose acetate, or any of the other above-described cellulosic materials. Certain cellulosic materials, such as hydroxyethyl cellulose and hydroxypropyl cellulose can have degrees of substitution greater than 3. In preferred embodiments, the cellulosic material, e.g., cellulose acetate, has a degree of substitution that renders the cellulosic material soluble, at least in part, in the solvent employed in the process for manufacturing the anti-condensation composition, which is described in greater detail below.

The amount of cellulosic material, e.g., cellulose acetate, contained in the anti-condensation composition may also vary widely. In some aspects, the composition comprises the cellulosic material, e.g., cellulose acetate, in an amount from 20 to 95 wt. %, e.g., from 50 to 95 wt. % or from 60 to 90 wt. %, based on the total weight of the anti-condensation composition. As used herein, wt. % of the anti-condensation composition is determined assuming a dry basis, i.e., free of solvent.

The increased hydrophilicity may in turn allow for increased water absorption in the primary film, which beneficially may provide for a longer lasting anti-condensation effect. The combination of this longer lasting anti-condensation effect with the improvements in haze properties (as provided for by utilizing the specific composition of the precursor film) results in a highly desirable anti-condensation composition.

As discussed above, in preferred embodiments, the anti-condensation composition also comprises a polymer of an oxazoline. As used herein, the term “oxazoline” refers to substituted or unsubstituted five-membered heterocyclic chemical compounds containing one double bond and one atom each of oxygen and nitrogen within the five-membered heterocyclic ring structure. In some embodiments, the oxazoline is 2-oxazoline, having a structure of formula (I):

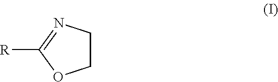

wherein R is hydrogen, an alkyl group, a carboxyl group, a hydroxyl group or an ether group. Alternatively, R may be selected from hydrogen, alkyl, hydroxyalkyl, carboxyl, hydroxyl, phenyl, or an ether group.

In some embodiments, the oxazoline has a structure of formula (II):

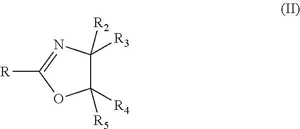

wherein R₁₋₅ are independently selected from the group consisting of hydrogen, alkyl, hydroxyalkyl, carboxyl, hydroxyl, phenyl, and ether groups. The oxazoline is optionally selected from the group consisting of 2-methyl-2-oxazoline, 2-ethyl-2-oxazoline, 2-n-propyl-2-oxazoline, 2-isopropyl-2-oxazoline, 2-phenyl-2-oxazoline, 2-n-butyl-2-oxazoline, 2,4,4-trimethyl-2-oxazoline, 2-(penta-4-ynyl)-2-oxazoline, 2-isopropenyl-2-oxazoline, 4,4-dimethyl-2-phenyl-2-oxazoline, 2-[1-(hydroxymethyl)ethyl] oxazoline and 2-hydroxy-2-oxazoline. In preferred embodiments, the oxazoline comprises 2-ethyl-2-oxazoline, and the resulting polymer comprises poly(2-ethyl-2-oxazoline) (PEOX). The oxazoline, optionally 2-ethyl-2-oxazoline, optionally has a boiling point from 120 to 140° C., e.g., from 125 to 130° C.

Oxazolines may be polymerized through well-known ring opening polymerization processes to form the corresponding polymer, as described by T. Saegusa and S. Kobayashi, Makromol. Chem., Macromol. Symp., 1, 23 (1986), and T. Saegusa, Y. Nagura, and S. Kobayashi, Macromolecules, 6, 495 (1973), which are incorporated herein by reference in their entireties. In some embodiments, the polymer of oxazoline comprises poly(2-ethyl-2-oxazoline). In some optional embodiments, a mixture of different oxazolines are co-polymerized, and the resulting polymer of an oxazoline may comprise an oxazoline co-polymer.

In preferred embodiments, the polymer of the oxazoline is soluble in a solvent used to form the anti-condensation compositions of the present disclosure. In some embodiments, for example, the polymer is soluble in acetone. Other possible solvents include ethanol, isopropanol, methyl ethyl detone (MEK), Dichloromethane, methanol and mixtures thereof. The polymer is also preferably soluble in water. Polymer solubility is influenced by molecular weight. Thus, although the molecular weight of the polymer may vary widely, in some optional embodiments, the polymer has a molecular weight ranging from 60,000 to 1,000,000 daltons, e.g., from 100,000 to 1,000,000 daltons, from 200,000 to 1,000,000 daltons, from 200,000 to 800,000 daltons, from 400,000 to 600,000 daltons, or from 60,000 to 600,000 daltons. Unless otherwise indicated, all MWs employed herein are in daltons. The polymer optionally has a polydispersity from 2-5, e.g., from 3-4, and optionally has a kinematic viscosity (10 wt. % in water @ 100° F. (38° C.)) ranging from 50 to 100 cSt, e.g., from 60 to 80 cSt. In some aspects, the polymer has high heat stability and may be thermally processed, e.g., extruded, when incorporated in the anti-condensation compositions of the present disclosure.

The anti-condensation composition of the present disclosure optionally may comprise the polymer of the oxazoline in an amount from 2 to 80 wt. %, e.g., from 2 to 40 wt. %, from 10 to 40 wt. %, or from 18 to 28 wt. %, based on the total weight of the anti-condensation composition. Greater amounts of the polymer of the oxazoline may increase brittleness, while amounts less than 2 wt. % may exhibit reduced anti-condensation benefits. In one aspect, for example, the polymer has a molecular weight from 60,000 to 1,000,000 daltons, e.g., from 100,000 to 1,000,000 daltons, from 200,000 to 1,000,000 daltons, from 200,000 to 800,000 daltons, from 400,000 to 600,000 daltons or from 60,000 to 600,000 daltons, and the composition comprises the polymer in an amount from 10 to 40 wt. %, e.g., from 18 to 28 wt. %, based on the total weight of the composition.

In order to improve processability and provide the desired mechanical properties for the anti-condensation composition, the anti-condensation composition optionally further comprises a plasticizer in an amount from 3 to 40 wt. %, e.g., from 3 to 20 wt. %, based on the total weight of the composition. The plasticizer may vary widely. Exemplary plasticizers may include, but are not limited to, 1,2,3-triacetoxypropane (triacetin), trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methyl pyrollidinone, propylene carbonate, C₁-C₂₀ diacid esters, dimethyl adipate (and other dialkyl esters), resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, aromas (including some described herein, e.g., eugenol, cinnamyl alcohol, camphor, methoxy hydroxy acetophenone (acetovanillone), vanillin, and ethylvanillin), and the like, any derivative thereof, and any combination thereof. In some embodiments, plasticizers may be food-grade plasticizers. Examples of food-grade plasticizers may include, but are not limited to, triacetin, trimethyl citrate, triethyl citrate, tributyl citrate, eugenol, cinnamyl alcohol, methoxy hydroxy acetophenone (acetovanillone), vanillin, ethylvanillin, polyethylene glycols, and the like, and any combination thereof.

In some embodiments, the plasticizer is selected, for example, from the group consisting of ethylene carbonate, propylene carbonate, and trimethylene carbonate. In other embodiments, the plasticizer is selected, for example, from the group consisting of 1,2,3-triacetoxypropane (triacetin), tributyl citrate, triethyl citrate, an alkyl phosphate, tris(chloroisopropyl)phosphate, dimethyl phthalate, bornan-2-one, PEG-DGE, PPG-DGE, tributyl phosphate, and mixtures thereof. In other embodiments, the plasticizer is selected, for example, from the group consisting of 1,2,3-triacetoxypropane (triacetin), tributyl citrate, diethyl phthalate, triethyl citrate, triphenyl phosphate, tris(chloroisopropyl)phosphate, dimethyl phthalate, bornan-2-one, PEG-DGE, PPG-DGE, tributyl phosphate, and mixtures thereof. In some embodiments, the plasticizer comprises a phthalate plasticizer. In some embodiments, the anti-condensation composition comprises, inter alia, diethyl phthalate and silica having an average particle size ranging from 0.02 microns to 6 microns. In some embodiments, the plasticizer does not comprise triacetin.

The anti-condensation composition optionally further comprises a surfactant in an amount from 0.1 to 3 wt. %, e.g., from 0.1 to 1.5 wt. %, based on the total weight of the film. The surfactant may be selected, for example, from the group consisting of a sorbitan ester, an ethoxylated sorbitan ester, ethoxylate surfactants, fatty alcohol ethoxylates, alkyl phenols ethoxylate, a fluorosurfactant, a nonionic surfactant, an anionic surfactant, and a cationic surfactant. Where the surfactant comprises a sorbitan ester, the sorbitan ester is optionally selected from the group consisting of sorbitan monolaurate, sorbitan monopalmitate, sorbitan monostearate, sorbitan monooleate, sorbitan sesquioleate, sorbitan trioleate, sorbitan isostearate, and sorbitan tristearate. Where the surfactant comprises an ethoxylated sorbitan ester, the ethoxylated sorbitan ester is optionally selected from the group consisting of polyethylene glycol-20 (PEG-20) sorbitan monolaurate, PEG-4 sorbitan monolaurate, PEG-20 sorbitan monopalmitate, PEG-20 sorbitan monostearate, PEG-4 sorbitan monostearate, PEG-20 sorbitan tristearate, and PEG-20 sorbitan monooleate. Surprisingly and unexpectedly, it has been found that the choice of surfactant used in the anti-condensation composition can have an effect on the anti-fogging characteristics of the composition. In particular, anionic fluorosurfactants have surprisingly and unexpectedly been found to greatly increase the anti-fogging characteristics of the anti-condensation composition.

In some embodiments, the anti-condensation composition, and the dope used to form the anti-condensation composition, may further comprise one or more additional additives, e.g., tackifiers, flame retardants, antioxidants, antibacterial agents, antifungal agents, colorants, pigments, dyes, UV-stabilizers, viscosity modifiers, processing additives, aromas, and the like, and any combination thereof. The amount of the additives may vary widely. Generally, the one or more additives may be present in an amount ranging from 0.01 to 10 wt. %, based on the total weight of the anti-condensation composition, e.g., from 0.03 to 2 wt. % or from 0.1 to 1 wt. %.

In some embodiments, UV absorber additives may be included in the anti-condensation composition. For example, the anti-condensation composition (with a UV absorber additive) may be utilized in a situation where UV light may damage the contents enclosed by the anti-condensation composition. One example may include a refrigerator or freezer in which the anti-condensation composition (with a UV absorber additive) is utilized to protect meat or fish from potentially damaging UV light.

Flame retardants suitable for use in conjunction with the anti-condensation composition described herein may, in some embodiments, include, but are not limited to, phosphates, catechol phosphates, resorcinol phosphates, aromatic polyhalides, and the like, and any combination thereof.

Antifungal agents suitable for use in conjunction with the anti-condensation composition described herein may, in some embodiments, include, but are not limited to, polyene antifungals, e.g., natamycin, rimocidin, filipin, nystatin, amphotericin B, candicin, and hamycin, imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, and any combination thereof.

Colorants, pigments, and dyes suitable for use in conjunction with the anti-condensation composition described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, nickel titanate, benzimidazolone orange gl, solvent orange 60, orange dyes, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL Brilliant Yellow K-6G liquid, CARTASOL Yellow K-4GL liquid, CARTASOL Yellow K-GL liquid, CARTASOL Orange K-3GL liquid, CARTASOL Scarlet K-2GL liquid, CARTASOL Red K-3BN liquid, CARTASOL Blue K-5R liquid, CARTASOL Blue K-RL liquid, CARTASOL Turquoise K-RL liquid/granules, CARTASOL Brown K-BL liquid), FASTUSOL® dyes (an auxochrome, available from BASF) (e.g., Yellow 3GL, Fastusol C Blue 74L), and the like, any derivative thereof, and any combination thereof. In some embodiments, when titanium dioxide is utilized as the colorant, the titanium dioxide may also function to increase the stiffness of the film. In some embodiments, solvent dyes may be employed.

In some embodiments, colorants, pigments and dyes suitable for use in conjunction with the anti-condensation composition described herein may be food-grade pigments and dyes. Examples of food-grade pigments and dyes may, in some embodiments, include, but are not limited to, plant dyes, vegetable dyes, Quinoline Yellow, Sunset Yellow FCF, Orange Yellow S, Azorubine, Carmoisine, Amaranth, Allura Red AC, Patent Blue V, Indigotine, Indigo carmine, Brilliant Blue FCF, Green S, Iron oxides and hydroxides, Brilliant Black 1, Aluminum, Curcumin, Riboflavins, Lycopene, Beta apo-8′carotenal, Lutein, Canthaxanthin, and the like, and any combination thereof.

Aroma agents, e.g., fragrances, suitable for use in conjunction with the anti-condensation composition described herein may, in some embodiments, include, but are not limited to, spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vannillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, bergamot, strawberry, carnation, oregano, honey, civet, heliotrope, caramel, coumarin, patchouli, dewberry, helonial, bergamot, hyacinth, coriander, pimento berry, labdanum, cassie, bergamot, aldehydes, orchid, amber, benzoin, orris, tuberose, palmarosa, cinnamon, nutmeg, moss, styrax, pineapple, bergamot, foxglove, tulip, wisteria, clematis, ambergris, gums, resins, civet, peach, plum, castoreum, civet, myrrh, geranium, rose violet, jonquil, spicy carnation, galbanum, hyacinth, petitgrain, iris, hyacinth, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassie, African tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana wacapua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaican pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South American tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

### Performance Characteristics

The anti-condensation compositions of the present disclosure preferably have desirable anti-fogging characteristics, which may be quantified by a “condensation time” test. Except where otherwise indicated herein, condensation time is determined by placing an anti-condensation composition of the present disclosure, e.g., film, coating, or laminate, over a 250 mL beaker of water that has been heated to approximately 50° C., and measuring the time taken until an initial fogging of the film or coating is detected, if any. The sample is placed at a predetermined distance from the film, e.g., approximately 6 cm. In some exemplary embodiments, the anti-condensation composition has a condensation time greater than 10 seconds, e.g., greater than 20 seconds, greater than 30 seconds, greater than 40 seconds, greater than 50 seconds, greater than 60 seconds, or greater than 70 seconds. In terms of ranges, the anti-condensation composition may have a condensation time ranging from 10 seconds to 200 seconds, e.g., from 20 seconds to 150 seconds, from 20 seconds to 100 seconds, or from 30 seconds to 90 seconds. Alternatively, test methods EN166 and/or EN168.16 may be utilized to determine condensation time.

In addition to having desirable anti-condensation characteristics, the anti-condensation compositions of the present disclosure preferably exhibit low haze values, as tested according to ASTM D1003-13 (2013). For example, the compositions may have a haze value less than 2%, e.g., less than 1.5%, less than 1.2%, or less than 1%. In terms of ranges, the anti-condensation composition may have a haze value ranging from 0 to 2%, from 0.01% to 4%, from 0.1% to 1.5%, from 0.2% to 1%, or from 0.6% to 1%. The haze value may be measured using a hazemeter. Unless otherwise indicated herein, haze values are determined using properly sized specimens having substantially plane-parallel surfaces, e.g., flat without wrinkling, free of dust, scratches, and particles, of about 0.85 mm in thickness using an EEL57D Spherical Hazemeter from Diffusion Systems Ltd. in conformance with ASTM D1003-13 (2013) and BS2782-0:2011. In preferred embodiments, the composition has a condensation time greater than 10 seconds and a haze value ranging from 0.01% to 4%.

In some embodiments, the anti-condensation composition has haze A ranging from 0% to 10% as determined measuring haze before and after rubbing with a microfiber cloth under 1 pound of weight, e.g., from 0% to 5%, from 0% to 1%, or from 0% to 0.1%. In terms of lower limits, the anti-condensation composition may have a haze A less than 10%, e.g., less than 5%, less than 1% or less than 0.1%.

It has now also been discovered that the anti-condensation compositions of the present disclosure may exhibit a high degree durability, as exemplified by the Pencil Hardness Test, wherein 9H is the hardest value, followed by 8H, 7H, 6H, 5H, 4H, 3H, 2H, and H; F is the middle of the hardness scale followed by HB, B, 2B, 3B, 4B, 5B, 6B, 7B, 8B, and 9B (softest). As used herein, the Pencil Hardness Test refers to ASTM test standard D3363-05(2011)e2 in which pencil hardness is reported as the hardest pencil that would scratch the surface. In preferred embodiments, the compositions of the present disclosure exhibit pencil harness values greater than HB, e.g., greater than F, greater than H, greater than 2H, or greater than 4H. In terms of ranges, the composition, e.g., in the form of a coating, film, or laminate, preferably exhibits a pencil hardness ranging from 2B-4H, preferably from HB to 4H, from F to 4H, or from H to 4H.

In some embodiments, the anti-condensation composition has a moisture (water) vapor transmission rate (MVTR) ranging from 25 g/m²/day to 3000 g/m²/day (at 25° C. and 75% relative humidity), e.g., 100 g/m²/day to 1000 g/m²/day, from 200 g/m²/day to 1000 g/m²/day, from 250 g/m²/day to 750 g/m²/day or from 500 to 750 g/m²/day. In terms of lower limits, the anti-condensation composition may have a water vapor transmission rate greater than 100 g/m²/day, e.g., greater than 200 g/m²/day, or greater than 250 g/m²/day. In terms of upper limits, the anti-condensation composition may have a water vapor transmission rate less than 1000 g/m²/day, e.g., less than 900 g/m²/day, or less than 750 g/m²/day. Water vapor transmission rate may be measured by gravimetric techniques. In some embodiments, the water vapor transmission rate is measured as noted in one of the following ASTM test standards: ASTM F1249-06 (2006), ASTM E398-03 (2003), ASTM D1434-82(2015), ASTM D3079-94(2009), ASTM D4279-95(2009), ASTM E96-16 (2016), ASTM E398-13 (2013), or ASTM F1249-13 (2013).

In some embodiments, the anti-condensation composition has a transparency ranging from 40% to 100%, as measured by ASTM D1746-15 (2015), e.g., from 70% to 90%. In terms of lower limits, the anti-condensation composition may have a transparency greater than 40%, e.g., greater than 70%. In terms of upper limits, the anti-condensation composition may have a transparency less than 100%, e.g., less than 90%.

In some embodiments, the anti-condensation composition has a light diffusion ranging from 0.1 cd/m²/lx to 0.26 cd/m²/lx as measured by EN 167:2002 4, e.g., from 0.15 cd/m²/lx to 0.25 cd/m²/lx. In terms of lower limits, the anti-condensation composition may have a light diffusion greater than 0.1 cd/m²/lx, e.g., greater than 0.15 cd/m²/lx. In terms of lower limits, the anti-condensation composition may have a light diffusion less than 0.26 cd/m²/lx e.g., less than 0.25 cd/m²/lx.

In some embodiments, the anti-condensation composition has a gloss ranging from 100 to 200 as measured by ASTM D523-14 (2014), e.g., from 125 to 175, or from 145 to 155. In terms of lower limits, the anti-condensation composition may have a light diffusion greater than 100, e.g., greater than 125 or greater than 145. In terms of upper limits, the anti-condensation composition may have a light diffusion less than 200 e.g., less than 175 or less than 155.

In some embodiments, the anti-condensation composition has a tensile strength ranging from 40 Nmm⁻² to 140Nmm⁻², as measured by ASTM D882-12 (2012), e.g., from 70 Nmm⁻² to 110 Nmm⁻². In terms of lower limits, the anti-condensation composition may have a tensile strength greater than 40 Nmm⁻², e.g., greater than 70 Nmm⁻². In terms of upper limits, the anti-condensation composition may have a tensile strength less than 140 Nmm⁻², e.g., less than 90 Nmm⁻².

In some embodiments, the anti-condensation composition has an elongation ranging from 10% to 60%, as measured by ASTM D882-12 (2012), e.g., from 25% to 55% from from 10% to 55%. In terms of lower limits, the anti-condensation composition may have an elongation greater than 10%, e.g., greater than 20%, or greater than 25%. In terms of upper limits, the anti-condensation composition may have an elongation less than 60%, e.g., less than 55%.

In some embodiments, the anti-condensation composition has a Young's modulus ranging from 1400 Nmm⁻² to 3500 Nmm⁻², as measured by ASTM D882-12 (2012), e.g., from 1600 Nmm⁻² to 2400 Nmm⁻², or from 1800 Nmm⁻² to 2200 Nmm⁻². In terms of lower limits, the anti-condensation composition may have a Young's modulus greater than 1400 Nmm⁻², e.g., greater than 1600 Nmm⁻², or greater than 1800 Nmm⁻². In terms of upper limits, the anti-condensation composition may have a Young's modulus less than 3000 Nmm⁻², e.g., less than 2600 Nmm⁻² or less than 2400 Nmm⁻².

In some embodiments, the anti-condensation composition comprises residual acetone from the manufacturing process. For example, the anti-condensation composition may comprise from 0.01 wt % to 3 wt % acetone, e.g., from 0.05 wt % to 2 wt %, from 0.05 wt % to 1 wt %, or from 0.05 to 0.5 wt %. In terms of lower limits, the anti-condensation composition may comprise at least 0.01 wt % acetone, e.g., at least 0.05 wt % or at least 0.1 wt %. In terms of upper limits, the anti-condensation composition may comprise less than 3 wt % acetone, e.g., less than 2 wt %, less than 1 wt %, less than 0.5 wt %, or less than 0.1 wt %.

The form of the anti-condensation composition may vary widely. In various embodiments, the anti-condensation composition may be in the form of a film, coating, laminate, or shaped consumer product, e.g., extruded consumer product. In some embodiments, the composition has a thickness from 5 to 4000 μm. As used herein, the term “film” refers to compositions, whether adhered or unadhered to a substrate, having a thickness from 50 to 4000 μm, and the term “coating” refers to compositions, whether adhered or unadhered to a substrate, having a thickness less than 50 μm. The coating or film typically will have opposing major planar surfaces, at least one of which may be adhered onto a substrate. Thus, in some embodiments, a consumer product includes a surface and the anti-condensation composition, e.g., in film or coating form, is disposed on that surface, whether as a coating, film or otherwise attached to the surface.

Whether in film, coating, or laminate form, the composition may comprise a single layer or may be combined into multiple layers of the same or different type, and may or may not comprise discrete layers. In exemplary embodiments, the anti-condensation composition has a thickness ranging from 25 microns to 2000 microns, e.g., from 25 microns to 1000 microns, from 25 microns to 750 microns, from 50 microns to 500 microns, or from 75 microns to 200 microns. In terms of lower limits, the thickness of the composition may be greater than 25 microns, e.g., greater than 50 microns or greater than 75 microns. In terms of upper limits, the thickness of the composition may be less than 2000 microns, e.g., less than 1000 microns, less than 750 microns, less than 500 microns, or less than 200 microns. Thicknesses may be measured via the methods known in the art, e.g., infrared scanning or with a mechanical film thickness measuring instrument.

When in the form of a shaped consumer product, the form itself may vary widely. The consumer products thus formed beneficially are able to be utilized in applications requiring a high degree of structural thickness and/or rigidity, e.g., (protective) goggles, visors, masks, or wind screens. In several preferred embodiments, the consumer product is selected from the group consisting of lenses, windows, screens, glass structures, containers, appliances, plastic, refrigerating devices, optical devices, and visors.

The list of contemplated consumer products is vast. As one example, the consumer product may be selected from the group consisting of lenses, windows, screens, glass structures, containers, appliances, plastic, optical devices, and visors. In some embodiments, the consumer product is a refrigerating device, e.g., a refrigerator, a cooler, or a freezer. The anti-condensation composition may be adhered to the consumer product, e.g., the planar surface of the consumer product, with an adhesive. Of course, the adhesive may vary widely and many suitable adhesives are known in the art.

Generally, any consumer product that has a potential for moisture interaction, e.g., humidity, fogging, dew accumulation, etc., may be a consumable product suitable for use with the anti-condensation compositions of the present disclosure.

Examples of other consumer products include, but are not limited to, furniture or components thereof, e.g., carpet and/or fabric coated headboards, chairs, and stools, picture frames, self-adhesive window coverings, e.g., decorative window stickers, window films, and window tinting, light films, light filters, and the like.

In some embodiments, the consumer product includes bags, windows for boxes, wraps, camera lenses, windows, e.g., automotive windows, airplane windows, televisions, any product that utilizes a glass or protective glass, e.g., windows or balcony enclosures.

Suitable substrates or surfaces (of consumer products) for use with the anti-condensation compositions described herein may, in some embodiments, comprise materials that include, but are not limited to, ceramics, natural polymers, synthetic polymers, metals, natural materials, carbons, and the like, and any combination thereof. Examples of ceramics may, in some embodiments, include, but are not limited to, glass, quartz, silica, alumina, zirconia, carbide ceramics, boride ceramics, nitride ceramics, and the like, and any combination thereof. Examples of natural polymers may, in some embodiments, include, but are not limited to, cellulose, and the like, any derivative thereof, and any combination thereof. Examples of synthetic polymers may, in some embodiments, include, but are not limited to, cellulose diacetate, cellulose triacetate, synthetic bamboo, rayon, acrylic, aramid, nylon, polyolefins, polyethylene, polypropylene, polyesters, polyamides, zylon, and the like, any derivative thereof, and any combination thereof. Examples of metals may, in some embodiments, include, but are not limited to, steel, stainless steel, aluminum, copper, and the like, any alloy thereof, and any combination thereof. Examples of natural materials may, in some embodiments, include, but are not limited to, wood, grass, animal hide, and the like, and any combination thereof. Examples of carbons may, in some embodiments, include, but are not limited to, carbon fibers, and the like, any derivative thereof, and any combination thereof.

Additional examples of substrates suitable for use in conjunction with the anti-condensation compositions described herein may, in some embodiments, include, but are not limited to, wood and/or grass derived substrates, e.g., wood veneers, particle board, fiberboard, medium-density fiberboard, high-density fiberboard, oriented strand board, cork, hardwoods, e.g., balsa wood, beech, ash, birch, Brazil wood, cherry, chestnut, elm, hickory, mahogany, maple, oak, rosewood, teak, walnut, locust, mango, alder, and the like, softwoods, e.g., pine, fir, spruce, cedar, hemlock, and the like, rough lumber, finished lumber, natural fibrous material, and bamboo, foam substrates, e.g., memory foams, polymer foams, polystyrene foam, polyurethane foam, frothed polyurethane, and soy-based foams, and the like, and any combination thereof.

In some embodiments, the anti-condensation consumer product may be further treated to impart additional desirable characteristics. As one example, the anti-condensation consumer product may be further coated. For example, the consumer product may be hard coated to form a coated anti-condensation consumer product. The coated anti-condensation consumer product may then be mirror coated through a sputter coating process to form a mirror coated consumer product. The resultant consumer product has a mirror coated effect on a surface thereof. This process is particularly well suited in forming, for example, sunglasses and goggles.

In some embodiments, a colored anti-condensation consumer product may be desired. The anti-condensation consumer product may be colored to yield a colored anti-fog consumer product. Many coloring techniques are known in the art, including dip dying and addition of coloring agent, e.g., dye or pigment. In some embodiments, the anti-condensation consumer product is dip dyed to yield a colored anti-condensation consumer product. In some embodiments, the precursor composition further comprises a coloring agent, preferably a dye or a pigment.

The configuration and/or dimensions of the anti-condensation compositions also may vary widely. In some cases, the anti-condensation composition may comprise one layer, e.g., as a primary film. In other embodiments, the anti-condensation composition may comprise multiple layers, e.g., 2 or more layers, 3 or more layers, 4 or more layers or 5 or more layers. In this aspect, the thickness of the anti-condensation composition (including all layers) may range from 200 microns to 4000 microns, e.g., from 200 to 2000 microns, from 200 microns to 1000 microns, from 250 microns to 750 microns, or from 275 microns to 500 microns. In terms of lower limits, the thickness of the anti-condensation composition may be greater than 200 microns, e.g., greater than 250 microns or greater than 275 microns. In terms of upper limits, the thickness of the anti-condensation composition may be less than 4000 microns, e.g., less than 2000 microns, less than 1000 microns, less than 750 microns, less than 500 microns, or less than 200 microns. In embodiments in which multiple layers are employed, the layers may be adhered to one another, e.g., laminated or attached to one another, optionally with an adhesive. The term “adhered” broadly encompasses any method used to connect multiple layers and may or may not involve the use of a separate adhesive. In some embodiments, adhering may be achieved by contacting the layers with acetone and stacking the contacted layers, to form a bond between the layers. In other embodiments, especially where greater thickness is preferred, an adhesive may be employed to adhere the layers to one another. Various adhesives are known in the art. In some embodiments, the primary film (and the anti-condensation composition as a whole) may be in the form of a rolled sheet.

Although not required, in some embodiments, the anti-condensation composition further comprises a protective film. The protective film may be adhered to at least one of the major planar surfaces. In some cases, the protective film may be adhered to only one major planar surface. The protective film may be a fairly low tack film that protects the anti-condensation composition, e.g., the surface thereof, from damage, e.g., physical, light-related, or chemical damage. In use, the protective film may be peeled away from the anti-condensation composition, optionally after application to a suitable substrate. The specific composition of the protective film may vary widely. In some embodiments, the protective film comprises a protective material selected from polyesters, polyethylenes, and polyethylene terephthalate. The protective film may be adhered to at least one of the major planar surfaces with a suitable adhesive, e.g., an acrylic polymer.

In some cases, the anti-condensation composition comprises an adhesive layer attached to one major planar surface. In some embodiments, the anti-condensation composition comprises an adhesive layer adhered to one major planar surface and a protective layer attached, e.g., adhered, to the other major planar surface. The adhesive layer may then have a release film attached thereto. The anti-condensation composition may be in the form of a flat sheet or rolled sheet.

In some configurations, the anti-condensation composition comprises the primary film and a secondary film. The secondary film may be adhered to the primary film. In some embodiments, the secondary film has substantially the same composition as the primary film. This configuration may be useful when a greater thickness and a uniform composition are desired. In some embodiments, multiple precursor layers may be formed and then stacked upon one another, e.g., to achieve a thicker precursor film. The stacked precursor film may or may not then be treated with caustic solution. In this context, it should be noted that although the present subject matter beneficially allows for the creation of anti-condensation compositions without the need for a saponification step, in other embodiments, saponification, e.g., treating with a caustic solution such as sodium hydroxide, may be employed. This optional saponification step may be employed where only a single film is formed or where multiple films are adhered together.

In some embodiments, the secondary film has a composition different from the primary film. This configuration may be useful when a larger thickness is desired, but a uniform composition is not necessary, e.g., when only the surface of the film requires anti-condensation characteristics, and the central or middle region does not require anti-condensation characteristics. For example, the secondary film may comprise cellulose acetate, and the cellulose acetate in the secondary film may have a degree of substitution greater than that of the primary film, e.g., outer major planar surface of the primary film, which preferably has a degree of substitution as discussed herein. For example, the primary film may comprise the cellulosic material and the polymer of the oxazoline, while the secondary film may comprise a different anti-condensation material, optionally a saponified film. In some embodiments, the anti-condensation composition employs the primary film (with anti-condensation characteristics) on one side of the composition and a secondary layer that does not have anti-condensation characteristics. Such a configuration may be useful in cases where the end substrate is used in colder temperatures, e.g., ski/skydiving goggles, airplane windows.

In some embodiments, one or more films are utilized in conjunction with the primary film. Suitable adhesives, e.g., ethylene-vinyl acetate adhesives, may be utilized to attach the primary film to the additional film(s). Many film layers can be utilized, e.g., more than 3, more than 4, or more than 5. In some embodiments, as noted above, acetone can be contacted with the primary film and/or to one or more additional films to adhere the layers to one another.

### Laminates

In some embodiments, the present disclosure is directed to a laminate including at least one layer comprising an anti-condensation composition (“the ant-condensation layer”) adhered to a core layer. The core layer may comprise a plurality of core layers that are adhered together, e.g., laminated. The anti-condensation layer comprises a cellulosic material selected from cellulose, a cellulose ester, a cellulose ether, an ether cellulose ester, nitrocellulose, and mixtures thereof and polymer of oxazoline having an average molecular weight greater than 50,000 daltons. In some embodiments, the anti-condensation layer comprises any of the anti-condensation compositions described above. The anti-condensation layer may be laminated to the top and/or bottom of the one or more core layers. In preferred embodiments, the laminate may comprise one or more core layers sandwiched between at least two anti-condensation layers. For example, the anti-condensation layer may be extruded or coated on each side of the core layer. In some embodiments, the outer layers comprise anti-condensation layers, and the inner core layer is a plasticized material.

The core layer may comprise cellulosic materials, e.g., cellulose acetate, and a plasticizer. The amount of cellulosic material, e.g., cellulose acetate, contained in the one or more core layers may vary. In some embodiments, the one or more core layers comprise the cellulosic material, e.g., cellulose acetate, in an amount from 65 to 98 wt. %, e.g., from 70 to 95 wt. % or from 80 to 90 wt. %, based on the total weight of the core layer composition. As used herein, wt. % of the core layer composition is determined assuming a dry basis, i.e., free of solvent.

In some embodiments, the cellulosic material of the core layer may be selected from, for example, cellulose, a cellulose ester, a cellulose ether, an ether cellulose ester, nitrocellulose, including optionally derivatives thereof and mixtures thereof. A non-limiting list of exemplary cellulose esters includes cellulose acetate, cellulose acetate propionate, cellulose acetate butyrate, cellulose acetate phthalate, cellulose acetate succinate, calcium carboxymethyl cellulose, carboxymethyl cellulose acetate butyrate, potassium cellulose succinate, and sodium cellulose succinate. A non-limiting list of exemplary cellulose ethers includes methyl cellulose, ethyl cellulose, propyl cellulose, hydroxymethyl cellulose, hydroxyethyl cellulose, hydroxypropyl cellulose, cellulose gum, methyl ethylcellulose, and various mixtures thereof. A non-limiting list of exemplary cellulose derivatives that include one or more ester and ether components in the same polymer includes carboxymethyl hydroxyethylcellulose, carboxy acetate propionate, cetyl hydroxyethylcellulose, hydrolyzed cellulose gum, hydroxylbutyl methylcellulose, hydroxyethyl ethylcellulose, hydroxypropyl methylcellulose, hydroxypropyl methylcellulose acetate/succinate, methyl hydroxyethylcellulose, and various mixtures thereof. Additionally or alternatively, the anti-condensation composition may comprise a plurality of different cellulose esters (e.g., both cellulose acetate and cellulose butyrate) and/or a plurality of different cellulose ethers and/or blends of cellulose ethers and cellulose esters.

In some embodiments, the core layer may comprise from 65 to 98 weight percent cellulose acetate and from 2 to 35 weight percent plasticizer, e.g., from 5 to 30 wt. % or from 10 to 20 wt. %, based on the total weight of the core layer composition. The plasticizer may be selected, for example, from the group consisting of triacetintrimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methyl pyrollidinone, C₁-C₂₀ diacid esters, dimethyl adipate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, and mixtures thereof. In preferred embodiments, the plasticizer is a low water-solubility plasticizer selected from, for example, the group consisting of phosphate plasticizers, acetyl trimethyl cictrate, acetyl triethyl citrate, acetyl tributyl citrate, dimethyl sebacate, di-n-butyl sebacate, dioctyl sebacate, diisodecyl adipate, dibutoxylethyl adipate, dibutoxyethoxylethyl sebacate, dibutyl phthalate, diaryl phthalate, dethyl phthalate, di-octyl phthalate (and isomers), di-n-heptyl phthalate, di-2-ethylhexyl phthalate, diisononyl phthalate, diisodecyl phthalate, diundecyl phthalate, tri-2-ethylhexyl trimellitate, tri-(7C-9C(linear)) trimellitate, dibutyl tartrate, polyethylene glycol diesters, epoxidized soy bean oil, castor oil, linseed oil, expoxidized linseed oil, other vegetable oils, polymeric polyester plasticizers, and combinations thereof. In other embodiments, the plasticizer may be a phosphate plasticizer, e.g., tris(chloroisopropyl)phosphate.

In some embodiments, the core layer further comprises other processing aids. For example, the core layer may include a surfactant in an amount from 0.1 to 3 wt. %, based on the total weight of the core layer. The surfactant may be selected from the group consisting of a polysorbate 20, sorbitan ester, an ethoxylated sorbitan ester, ethoxylate surfactants, fatty alcohol ethoxylates, alkyl phenols ethoxylate, a fluorosurfactant, a nonionic surfactant, an anionic surfactant, and a cationic surfactant. In some embodiments, the core layer may further comprise stearic acid and silica.

In some embodiments, the laminate is formed using a solvent casting process. For example, the laminate can be made on a production casting machine where the components are mixed together, e.g., in a mixer, and then cast through a dye onto a heated band. In other embodiments, the core sheets may be coated with either a lamination polymer or a plasticizer and heated to adhere the layers. In some embodiments, the anti-condensation layer can be coating or extruded onto the core layer. Conversely, the one or more core layers can be coated or extruded onto the anti-condensation layer.

Lamination of the anti-condensation film or layer to the core layer improves the mechanical properties of the anti-condensation film or layer. It is common for the properties of a single material to be insufficient to meet the performance requirements of a desired application. To obtain the desired performance, different materials may be brought together to form a laminate structure. Examples of such laminates include combination of a flexible material with a less flexible (e.g., structural) material. However, in many cases, the materials to be combined are not sufficiently compatible to provide the necessary high performance laminate structure.

In this respect, an anti-condensation layer comprising PEOX tends to have a very high Young's modulus and may be very stiff. See Table 20. Due to the stiffness of the anti-condensation films comprising PEOX, lamination to an inner core of more pliable material may be preferred. However, PEOX may have negative interactions with certain plasticizers and additives, e.g., triacetin, causing migration of these additives from the laminate over time. That is, the PEOX may decrease the stability of some additives in the laminate other than cellulose acetate. This may negatively impact the anti-condensation performance of the laminate over time. But, when the PEOX layer is laminated to a core comprising a low water-solubility plasticizer, e.g., tris(chloroisopropyl)phosphate, with a non-interacting core, the additives do not migrate from the laminate. Thus, lamination of the anti-condensation layer provided a more stable high performance material with desirable anti-condensation properties.

### Processes for Producing the Anti-Condensation Compositions

The present subject matter also is directed, in some embodiments, to processes for producing the anti-condensation compositions disclosed herein. In some embodiments, for example, the present disclosure is directed to a solvent casting process for forming the anti-condensation composition. The process comprises the steps of (a) combining a solvent, a cellulosic material, a polymer of an oxazoline, optionally a plasticizer and optionally a surfactant, to form a dope; and (b) casting, e.g., solvent casting, the dope to form the anti-condensation composition. Processes for preparing cellulose acetate films have been described in U.S. Pat. Nos. 2,232,012 and 3,528,833, the entireties of which are incorporated by reference herein. In general, the solvent casting process comprises casting a dope, which optionally comprises an anti-blocking agent. The components of the dope and the respective amounts determine the characteristics of the resulting composition.

In some embodiments, the present disclosure is directed to a process for producing an anti-condensation composition through a block polymer intermediate. In some embodiments, the process comprises the steps of: (a) combining a solvent, cellulosic material (e.g., cellulose acetate), a polymer of an oxazoline, optionally a plasticizer and optionally a surfactant, to form a dope; (b) removing the solvent to form a polymer block; and (c) planing the block to form the anti-condensation composition. In this aspect, the solvent removal or “casting” step preferably occurs on a band, and the surface is made surface smooth and optically clear.

In some embodiments, the present disclosure is related to a process for producing an anti-condensation composition in the form of pellets (which themselves can be considered an anti-condensation composition according some aspects of the present disclosure) and optionally using the pellets in a melt extrusion process to form the final anti-condensation composition. In some embodiments, the process comprises the steps of: (a) combining a solvent, a cellulosic material (e.g., cellulose acetate), a polymer of an oxazoline, optionally a plasticizer and optionally a surfactant, to form a dope; (b) removing the solvent to form a solid polymer composition; (c) pelletizing the solid polymer composition to form a pelletized polymer composition; and optionally (d) melt extruding the pelletized polymer composition to form the anti-condensation composition. The pellets may further comprise an antioxidant and/or a heat stabilizer. The process may further comprise the step(s) of washing the pellets to form washed pellets and/or drying the washed pellets.

In some embodiments, the present disclosure is related to a process for producing an anti-condensation composition from pelletized polymer pellets, the process comprising the steps of: (a) providing a pelletized polymer composition comprising a cellulosic material selected from a cellulose ester, a cellulose ether and mixture thereof, a polymer of an oxazoline, optionally a plasticizer and optionally a surfactant; and (b) melt extruding the pelletized polymer composition into a mold to form the anti-condensation composition.

In some embodiments, when an extrusion process is utilized to form the anti-condensation composition, antioxidants may, in some embodiments, mitigate oxidation and/or chemical degradation of the anti-condensation composition described herein during storage, transportation, and/or implementation. Antioxidants suitable for use in conjunction with the anti-condensation composition described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, ubiquinol, gallic acids, melatonin, secondary aromatic amines, benzofuranones, hindered phenols, polyphenols, hindered amines, organophosphorus compounds, thioesters, benzoates, lactones, hydroxylamines, and the like, and any combination thereof. In some embodiments, the antioxidant may be selected from the group consisting of stearyl 3-(3,5-di-tert-butyl-4-hydroxyphenyl) propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide and mixtures thereof.

In some embodiments, antioxidants suitable for use in conjunction with the anti-condensation compositions described herein may be food-grade antioxidants. Examples of food-grade antioxidants may, in some embodiments, include, but are not limited to, ascorbic acid, vitamin A, tocopherols, and the like, and any combination thereof.

In some melt extrusion-related embodiments, viscosity modifiers are employed. Viscosity modifiers suitable for use in conjunction with the anti-condensation composition described herein may, in some embodiments, include, but are not limited to, polyethylene glycols, and the like, and any combination thereof, which, in some embodiments, may be a food-grade viscosity modifier.

As described above, a mixture or “dope” may be prepared by dissolving the cellulosic material, e.g., cellulose acetate, and the polymer of the oxazoline in a solvent. In the above processes, the dope preferably comprises the solvent in an amount from 70 to 80 wt. %, the cellulosic material, e.g., cellulose acetate, in an amount from 5 to 15 wt. %, the polymer of the oxazoline in an amount from 1 to 10 wt. %, and the plasticizer (if present) in an amount from 0.1 to 5 wt. % and the surfactant (if present) in an amount from 0.01 to 1.5 wt. %. In this aspect, the weight percentages are based on the total weight of the dope, including solvent. Once the cellulosic material has been dissolved in the solvent, the mixture may be referred to as dope. The dope may then be filtered to remove impurities. In some embodiments, the filtering is a two-stage filtration.

In some embodiments, the dope comprises a cellulosic material selected from cellulose, a cellulose ester, a cellulose ether, an ether cellulose ester, nitrocellulose and mixtures thereof, a polymer of an oxazoline having an average molecular weight greater than 50,000 daltons, a solvent, and a plasticizer.

The specific solvent used to form the dope may vary widely, but optionally is selected from acetone, ethyl lactate, methyl ethyl ketone, methyl isobutyl ketone, ethyl acetate, isopropyl acetate, n-propyl acetate, isobutyl acetate, n-butyl acetate, 2-ethylhexyl acetate, diacetone alcohol, diethyl ether, ethylene glycol dimethyl ether, propylene glycol monopropyl ether, propylene glycol monobutyl ether, dipropylene glycol monomethyl ether, ethylene glycol diacetate, ethylene glycol monoethyl ether aceteate, methanol, propanol, isopropanol, methylene chloride, tetrahydrofuran, dimethyl formamide n-methyl-2-pyrrolidinone, dioxane, cyclohexanone, acetonitrile, dimethyl sulfoxide, nitromethane, chloroform, dichlormethane, ethylene dichloride and mixtures thereof.

To improve the solubility of cellulosic material in the solvent, the cellulosic material, the polymer of the oxazoline, and the solvent are preferably continuously added to a first mixer. The mixture may then be sent to a second and/or third mixer to allow for full dissolution of the cellulosic material and the polymer of the oxazoline in the solvent. The mixers may be continuous mixers that are used in series. It is understood that in some embodiments, one mixer may be sufficient to achieve dissolution. In other embodiments, two, three, or more mixers (e.g., four mixers, five mixers, or greater than five mixers) may be used in series or in parallel. In yet other embodiments, the cellulosic material, polymer of the oxazoline, solvent, and other additives may be combined in one or more blenders, separately or in combination, without the use of any mixers.

In various optional embodiments, the mixture may further comprise one or more processing additives. Additionally, the mixture may comprise one or more colorants. Plasticizer and/or surfactant may be added directly to the first mixer or may be blended with at least a portion of the solvent and then added to the first mixer. Similarly, the optional colorant, optional anti-blocking agent and/or other processing additives may be added directly to the first mixer or may be combined with a portion of the solvent and then added to the first mixer.

In some embodiments in which the dope is solvent casted, the cellulosic material is generally used in flake form. The (flake) cellulosic material, e.g., cellulose acetate, may then be dissolved in the solvent, e.g., acetone, to form the dope. Additional components, including the optional plasticizers and/or surfactants may be included with the dope. The dope may also comprise one or more of anti-blocking agents, stearic acid, dyes and/or one or more specialty chemicals. The components are then mixed as described above. The resultant mixture may then be filtered. The mixture then may be cast into a continuous film by die extrusion. The film may be dried in a warm air drying cabinet comprising rollers.

In some embodiments, after forming a mixture comprising cellulosic material, the polymer of the oxazoline, optional plasticizer and/or surfactant, and optional additives, the mixture may be melt extruded in a film die to form a sheet or melt extruded in a small hole die to form filaments which are then sent to a pelletizer to form pellets. The melt extrusion may be performed at a temperature of up to 230° C., e.g., up to 220° C. or up to 210° C. A temperature greater than 230° C. may lead to destabilization of the mixture components, particularly of the cellulosic material. The melt extruder may comprise a twin screw feeder with co-rotating screws, and may be operated at a screw speed from 100 to 500 rpm, e.g., from 150 to 450 rpm, or from 250 to 350 rpm. The sheet may have a thickness between 0.5 and 0.6 mm, e.g., from 0.53 to 0.54 mm.

The present subject matter is well adapted to attain the ends and advantages mentioned as well as those that are inherent therein. The particular embodiments disclosed above are illustrative only, as the present subject matter may be modified and practiced in different but equivalent manners apparent to those skilled in the art having the benefit of the teachings herein. Furthermore, no limitations are intended to the details of construction or design herein shown, other than as described in the claims below. While compositions and methods are described in terms of “comprising,” “containing,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

### EXAMPLES

### Examples 1-6: CA/PEOX with Various Additives

Six films were formed from a dope comprising a cellulosic material (cellulose acetate (CA)) and a polymer of oxazoline (PEOX) and using acetone as solvent. The formulations were prepared with various plasticizers (propylene carbonate (PrC), triacetin and diacetin) and without plasticizer and with and without ethoxylated sorbitan surfactant as shown in Table 1, below. The dope samples were cast into a thin film with a Gardco Automatic Drawdown Machine II on a 50 μm clear polyethylene terephthalate (PET) film and dried at room temperature in the chemical hood for overnight or longer. The resulting films were qualitatively observed in terms of appearance/clarity and anti-condensation performance of the films were tested using the experimental procedure described below.

To determine condensation time, deionized water was placed in a 250 ml conical Earlenmyer flask until the level reached 6 cm from the top. The flask was placed on a hotplate and heated to a temperature of 50° C. Film samples were individually placed on top of the beaker and a stop watch was started. A torch light was aimed at the sample at an angle of 45°. The stop watch was stopped when the first sign of fog was visible, and the result was recorded. The results are shown in Table 1. All percentages are weight percents based on the dry (solvent free) films.

TABLE 1
CA/PEOX Formulations with Various Additives

| Example | 1 | 2 | 3 | 4 | 5 | 6 |
|---|---|---|---|---|---|---|
| Acetone | 149.6 | 144.9 | 170 | 149.6 | 145.3 | 170 |
| (parts by wt) | | | | | | |
| Plasticizer | PrC | Triacetin | Diacetin | None | PrC | None |
| (parts by wt) | 4.7 | 4.7 | 4.7 | | 4.7 | |
| PEOX | 10 | 10 | 10 | 10 | 10 | 10 |
| (parts by wt) | | | | | | |
| CA Flake | 20 | 20 | 20 | 20 | 20 | 20 |
| (parts by wt) | | | | | | |
| % PEOX | 28.49% | 28.49% | 28.49% | 32.89% | 28.82% | 33.33% |
| % Surfactant | 1.14% | 1.14% | 1.14% | 1.32% | None | None |
| Cast Film | Transparent | Transparent | Transparent | Cloudy | Transparent | Clear |
| Appearance | | | | Haze; | | |
| | | | | separated | | |
| | | | | from | | |
| | | | | substrate | | |
| Condensation | >5 min | >5 min | >5 min | >5 min | 3 min | 2 min |
| Time | | | | | | |

### Examples 7-9: PEOX at Various Molecular Weights

Tests were conducted to determine the effect of molecular weight of the polymer of an oxazoline on film condensation properties. Four formulations were prepared as in Example 1, but with different molecular weight polymers of 2-ethyl-2-oxazoline. Comparative 1 was an example film formulation having a molecular weight of the oxazoline polymer of 5,000 daltons. The remaining films, Examples 7-9, have a molecular weight of the oxazoline polymer ranging from 50,000 to 500,000 daltons The resulting films were tested according to the condensation time test described above. Each of the examples were tested three times, both while on the PET substrate and after having been removed from the PET substrate. The results are shown in Table 2.

TABLE 2
Formulations with Various MW PEOX

| | Example | | | | | | | | | | | |
|---|---|---|---|---|---|---|---|---|---|---|---|---|
| | Comp. 1 | | 7 | | | | 8 | | | 9 | | |
| Acetone | 165.3 | | | 165.3 | | | 165.3 | | | 165.3 | | |
| (parts by wt) | | | | | | | | | | | | |
| Plasticizer | 4.7 | | | 4.7 | | | 4.7 | | | 4.7 | | |
| (parts by wt) | | | | | | | | | | | | |
| PEOX | 10 | | | 10 | | | 10 | | | 10 | | |
| (parts by wt) | | | | | | | | | | | | |
| CA Flake | 20 | | | 20 | | | 20 | | | 20 | | |
| (parts by wt) | | | | | | | | | | | | |
| PEOX MW | 5000 | | | 50000 | | | 200000 | | | 500000 | | |
| (daltons) | | | | | | | | | | | | |
| Film Thickness | 18-23 | | | 27-30 | | | 17-18 | | | 13-18 | | |
| (μm) | | | | | | | | | | | | |
| Condensation | 30 | 35 | 32 | 80 | 90 | 108 | 55 | 65 | 60 | 74 | 72 | 55 |
| times on PET | | | | | | | | | | | | |
| Substrate (s) | | | | | | | | | | | | |
| Stand Alone | 45 | 40 | 38 | 108 | 65 | 76 | 120 | 90 | 90 | 71 | 70 | 80 |
| Condensation | | | | | | | | | | | | |
| Times (s) | | | | | | | | | | | | |

In these examples, it was surprisingly and unexpectedly observed that as the molecular weight of the oxazoline polymer increased, with roughly the same film thickness, the condensation time also increased. For example, with roughly the same film thickness, the condensation time increased from about 30-35 seconds to 55-75 seconds when the molecular weight of the oxazoline polymer increased from 5000 to 500000 daltons, respectively. Specifically, Comparative 1 had a condensation time of 30-35 seconds, whereas Examples 7-9 had a condensation time of 55-108 seconds. The effects of PET substrate on anti-condensation time seemed also to depend on film thickness and molecular weight of the oxazoline polymer. In general, condensation time increased after removal of the substrate from the film, as well as with increasing film thickness.

It was also observed that whitish haze marks appeared on the films after the condensation tests were completed and the films were allowed to dry. These marks were most prevalent in Example 8, and decreased with increasing molecular weight, with Example 10 exhibiting the faintest haze mark. Subsequent testing indicated that the lower molecular weight oxazoline polymer in Example 8 appears to have a high tendency to be extracted out of the film upon contact with water, thereby forming the whitish haze marks.

### Examples 10-19: Mechanical Properties

Sample plaques were prepared by forming a dope comprising a cellulosic material (cellulose acetate), poly(2-ethyl-2-oxazoline), and a plasticizer. The dope was cast to form a thick substantially rigid film.

Multiple anti-condensation films were prepared as Examples 10-19 and compared with commercially available films (Comp. Examples 1-4). The hardness of the films was tested using the pencil hardness test, as defined by ASTM D3363 05(2011)e2. Before each test, a pencil was sharpened and then sanded to make an even, flat circle tip. The hardness of the films were tested by pushing a 1 kg sled with the pencil at a 45° angle across the film. The hardness of a film was recorded as the softest pencil that scratches the film. The results are shown below in Tables 3 and 4.

TABLE 3

| | | Polymer | Polymer | | |
|---|---|---|---|---|---|
| | | of | of | Plasticizer | |
| | | Oxazoline | Oxazoline | (Propylene | |
| | Thickness | MW | Conc | Carbonate) | Pencil |
| Example | (μm) | (kM_{w}) | (wt %) | Conc (wt %) | Hardness |
| 10 | 117 | 500 | 18 | 5 | HB |
| 11 | 130 | 200 | 23 | 14 | 3B |
| 12 | 263 | 200 | 23 | 14 | 3B |
| 13 | 250 | 500 | 23 | 14 | H |
| 14 | 240 | 500 | 23 | 5 | 2H |
| 15 | 230 | 500 | 18 | 14 | HB |
| 16 | 120 | 200 | 28 | 14 | 3B |
| 17 | 268 | 200 | 28 | 14 | 5B |
| 18 | 110 | 200 | 23 | 5 | 4B |
| 19 | 115 | 200 | 28 | 5 | 5B |

As shown in Table 3, Examples 10-19 surprisingly and unexpectedly exhibited excellent Pencil Test Hardness values, with thicker films exhibiting the greatest hardness values. In particular, Examples 13-15, having a thickness between 230-250 μm and a molecular weight of oxazoline polymer of 500,000 daltons, had a hardness value in the range from HB to 2H.

TABLE 4

| | | Thickness | Pencil |
|---|---|---|---|
| Example | Film Sample | (μm) | Hardness |
| Comp. 2 | CA with 19 wt. % | 115 | 3B |
| | Triacetin | | |
| Comp. 3 | Commercial 1 | 120 with | HB |
| | | adhesive | |
| Comp. 4 | Commercial 2 | 80 with | 2B |
| | | adhesive | |
| Comp. 5 | CA with 23 wt. % | 500 | 3B |
| | Propylene | | |
| | Carbonate | | |

Tables 3 and 4 demonstrate surprisingly and unexpectedly improved hardness values over the tested comparative formulations. For example, Comparative 2 having a thickness of 115 μm had significantly lower pencil hardness than Example 10 having roughly the same thickness.

The tensile properties of the films were measured in accordance with ASTM D882-12 (2012) and the tear properties were measured in accordance with ASTM D1938-14 (2014), and are shown in Table 5.

TABLE 5

| | | Tear Test | | | | | | | |
|---|---|---|---|---|---|---|---|---|---|
| | | Propagation | | | | Tensile | | Youngs | |
| | Measured | MD | TD | Elongation | | Stress @ Peak | | Modulus | |
| Ex. | Gauge | (N) | (N) | MD | TD | MD | TD | MD | TD |
| 10 | 117 | 0.30 | 0.31 | 23.4 | 22.6 | 92.2 | 92.1 | 2845.0 | 2916.7 |
| 11 | 130 | 0.33 | 0.36 | 21.8 | 26.2 | 83.1 | 80.5 | 2600.1 | 2417.6 |
| 12 | 263 | 1.02 | 1.20 | 26.4 | 43.1 | 70.2 | 68.8 | 1983.9 | 1934.4 |
| 13 | 250 | 10.9 | 1.27 | 31.6 | 35.1 | 74.8 | 67.3 | 2170.9 | 1900.6 |
| 14 | 240 | 0.89 | 1.05 | 28.2 | 30.7 | 79.8 | 71.0 | 2271.1 | 1976.1 |
| 15 | 230 | 0.97 | 1.06 | 32.3 | 39.3 | 82.0 | 74.2 | 2464.7 | 2194.7 |
| 16 | 120 | 0.27 | 0.28 | 14.0 | 17.0 | 80.3 | 95.0 | 2914.1 | 2740.1 |
| 17 | 268 | 1.18 | 1.38 | 19.2 | 37.6 | 71.2 | 67.8 | 2003.0 | 1863.8 |
| 18 | 110 | 0.20 | 0.22 | 23.6 | 33.1 | 92.7 | 88.8 | 2910.4 | 2818.3 |
| 19 | 115 | 0.20 | 0.23 | 17.8 | 19.2 | 97.1 | 89.1 | 2979.3 | 2682.1 |
| CA with 19% | 150 | N/A | N/A | 30-60 | 30-60 | 60-90 | 60-90 | 1600-1900 | |
| Triacetin (Comp. 6) | | | | | | | | | |

Contact Angle

The films were tested for water contact angle using an automated goniometer. The contact angle was measured by dropping a 2 microlitre drop onto the surface and the goniometer calculated the water contact angle. The values obtained for some samples were very low, and when repeated changed. But all values obtained were within the indicated ranges of Table 6 along with two additional commercial samples.

TABLE 6

| | | Water contact |
|---|---|---|
| Ex. | Gauge | angle |
| 10 | 117 | 8°-20° |
| 11 | 130 | 8°-20° |
| 12 | 263 | 8°-20° |
| 13 | 250 | 8°-20° |
| 14 | 240 | 8°-20° |
| 15 | 230 | 8°-20° |
| 16 | 268 | 8°-20° |
| 17 | 120 | 8°-20° |
| 18 | 110 | 8°-20° |
| 19 | 115 | 8°-20° |
| Comp. 7 | 120 | 30°-35° |
| Comp. 8 | 80 | 8°-20° |

Condensation Times

The anti-condensation performance of the films was tested using the experimental procedure described above but heating the water to 75° C., and the results are provided in Table 7 along with two comparative films.

TABLE 7

| | | Condensation |
|---|---|---|
| Example | Gauge | free time (s) |
| 10 | 117 | >90 |
| 11 | 130 | >90 |
| 12 | 263 | >90 |
| 13 | 250 | >90 |
| 14 | 240 | >90 |
| 15 | 230 | >90 |
| 16 | 268 | >90 |
| 17 | 120 | >90 |
| 18 | 110 | >90 |
| 19 | 115 | >90 |
| Comp. 9 | 120 | 30 |
| Comp. 10 | 500 | 20 |

Haze

Thick films were tested for haze under current ASTM D1003 (2015). The thick films had sufficient rigidity to be utilized in, for example, protective lenses or automotive lamp covers. The haze testing results are shown in Table 8. In each formulation, the plasticizer comprised propylene carbonate and the surfactant comprised an ethoxylated sorbitan ester.

TABLE 8

| | | MW of PEOX | | | | |
|---|---|---|---|---|---|---|
| | | sample (×1000) | PEOX | Plasticizer | Surfactant | |
| Ex. | Gauge | (daltons) | (wt. %) | (wt. %) | (wt. %) | Haze |
| 10 | 117 | 500 | 18 | 5 | 1 | 0.17 |
| 11 | 130 | 200 | 23 | 14 | 1 | 0.10 |
| 12 | 263 | 200 | 23 | 14 | 1 | 0.20 |
| 13 | 250 | 500 | 23 | 14 | 1 | 0.13 |
| 14 | 240 | 500 | 23 | 5 | 1 | 0.17 |
| 15 | 230 | 500 | 18 | 14 | 1 | 0.30 |
| 16 | 268 | 200 | 28 | 14 | 1 | 0.27 |
| 17 | 120 | 200 | 28 | 14 | 1 | 0.13 |
| 18 | 110 | 200 | 23 | 5 | 1 | 0.17 |
| 19 | 115 | 500 | 28 | 5 | 1 | 0.10 |

### Examples 20-27: Plasticizer Variation

Examples 20-27 were prepared similar to the formulations and films of Example 1, but incorporating various plasticizers and combinations of plasticizers as co-plasticizers. The plasticizers tested included triacetate (TRI), diethyl phthalate (DEP), a toluene sulfonamide (TSF), polyethylene glycol having an average molecular weight of 300 (PEG), tris(chloroisopropyl)phosphate (TCPP), and propylene carbonate (PRC). Formulation compositions are provided in Table 9 along with stand-alone condensation times for the resulting films at 75° C. water temperature. All formulations also included 0.06 parts by weight stearic acid as anti-blocking agent. All percentages are weight percentages based on the dry (solvent free) films.

TABLE 9
Plasticizer Combinations

| Example | 20 | 21 | 22 | 23 | 24 | 25 | 26 | 27 |
|---|---|---|---|---|---|---|---|---|
| Acetone | 240 | 240 | 240 | 240 | 240 | 240 | 240 | 240 |
| (parts by wt) | | | | | | | | |
| Plasticizer 1 | TRI | TRI | TRI | TRI | DEP | TRI | PEG | TCPP |
| (parts by wt) | 5.83 | 2.5 | 9.16 | 11.86 | 11.71 | 5.84 | 11.64 | 11.64 |
| Plasticizer 2 | PRC | PRC | PRC | None | None | TSF | None | None |
| (parts by wt) | 5.83 | 2.5 | 2.5 | | | 5.81 | | |
| PEOX | 23.32 | 23.32 | 23.32 | 23.32 | 23.44 | 23.42 | 23.34 | 23.39 |
| (parts by wt) | | | | | | | | |
| CA Flake | 47.43 | 54.09 | 47.43 | 23.32 | 23.44 | 23.42 | 23.34 | 23.39 |
| (parts by wt) | | | | | | | | |
| Surfactant | 0.83 | 0.83 | 0.83 | 0.83 | 0.83 | 0.83 | 0.83 | 0.83 |
| % PEOX | 28 | 28 | 28 | 27.97 | 28.12 | 28.14 | 28.05 | 28.13 |
| % Surfactant | 1.00 | 1.00 | 1.00 | 1.00 | 1.00 | 1.00 | 1.00 | 1.00 |
| % Plast. 1 | 7.00 | 3.00 | 11.00 | 14.23 | 14.05 | 7.02 | 13.99 | 14.00 |
| % Plast. 2 | 7.00 | 3.00 | 3.00 | — | — | 6.98 | — | — |
| % CA Flake | 56.94 | 64.93 | 56.94 | 47.30 | 47.33 | 47.26 | 47.35 | 47.24 |
| Film | 41-48 | 120-130 | 34-45 | 140-150 | 140-150 | 140-150 | 140-150 | 140-150 |
| Thickness | | | | | | | | |
| (μm) | | | | | | | | |
| Condensation | >5 min | >5 min | >5 min | >60 s | >90 s | >60 s | >60 s | >60 s |
| Time | | | | | | | | |
| Observations | No | No | No | No | White | No | White | No |
| | mark | mark | mark | mark | mark | mark | mark | mark |
| | after | after | after | after | after | after | after | after |
| | drying | drying | drying | drying | drying | drying | drying | drying |

### Examples 28-35: Surfactant Variation

Examples 28-35 were prepared similar to the formulations and films of Example 1, but with and without surfactant and incorporating various different surfactants, with and without plasticizer. The surfactants tested included two polyethoxylated sorbitan esters, polysorbate 80 (PS80) (polyethylene glycol-20 sorbitan monooleate) and polysorbate 20 (PS20) (polyethylene glycol-20 sorbitan monolaurate), and a sorbitan ester (SE) (sorbitan monolaurate). Formulation compositions are provided in Table 10 along with condensation times for the resulting stand-alone films at 50° C. water temperature. All percentages are weight percents based on the dry (solvent free) films.

TABLE 10
Surfactant Variation

| Example | 28 | 29 | 30 | 31 | 32 | 33 | 34 | 35 |
|---|---|---|---|---|---|---|---|---|
| Acetone | 149.6 | 144.9 | 148.8 | 170 | 170 | 170 | 170 | 170 |
| (parts by wt) | | | | | | | | |
| Plasticizer | None | PRC | None | None | None | PRC | PRC | None |
| (parts by wt) | | 4.7 | | | | 4.7 | 4.7 | |
| Surfactant | PS80 | PS80 | PS80 | None | PS20 | PS20 | SE | SE |
| (parts by wt) | 0.4 | 0.4 | 1.2 | | 0.4 | 0.4 | 0.4 | 0.4 |
| PEOX | 10 | 10 | 10 | 10 | 10 | 10 | 10 | 10 |
| (parts by wt) | | | | | | | | |
| CA Flake | 20 | 20 | 20 | 20 | 20 | 20 | 20 | 20 |
| (parts by wt) | | | | | | | | |
| % PEOX | 32.89 | 28.49 | 32.05 | 33.33 | 32.89 | 32.89 | 32.89 | 32.89 |
| % Surfactant | 1.32 | 1.14 | 3.85 | 0 | 1.32 | 1.32 | 1.32 | 1.32 |
| Condensation | >5 min* | >5 min | >5 min* | 2 min | 2 min | >5 min | >5 min | >5 min |
| Time | | | | | | | | |
| Observation | Transparent | Transparent | Transparent | Transparent | Pitted | — | White | White |
| | | | with | | surface | | mark | spots |
| | | | haze | | seen at | | after | formed |
| | | | | | 2 min | | test | after test |
| Separated | Yes | — | Yes | — | — | — | — | — |
| from | | | | | | | | |
| Substrate? | | | | | | | | |

*Results reported are for the film side that was facing the PET substrate. Shorter condensation times (2 min 10 sec, and 3 min, respectively) were observed for standalone tests where the film surface that was exposed to air during casting on the PET substrate was tested.

Examples 36-44 were prepared similar to the formulations and films of Example 1, but with triacetin as the plasticizer and incorporating various different surfactants. The surfactants tested include polysorbate 20 (PS20) (polyethylene glycol-20 sorbitan monolaurate), BRIJ L23 (polyoxyethylene lauryl ether), polyethylene glycol dimethyl ether (PEG-DME), a copolymer of polyethylene gycol and polypropylene glycol with molecular weight 2200 daltons (PEG-PPG Mw 2200), a copolymer of polyethylene gycol and polypropylene glycol with molecular weight 4400 daltons (PEG-PPG Mw 4400), PolyFox PF-151N, PolyFox PF-156A, and Triton X-100. Formulation compositions are provided in Table 11 along with condensation for the resulting stand-alone films at 50° C. water temperature. All percentages are weight percents based on the dry (solvent free) films.

TABLE 11
Surfactant Variation

| | Example | | | | | | | |
|---|---|---|---|---|---|---|---|---|
| | 36 | | 37 | | 38 | | 39 | |
| Acetone | 120.09 | | 120.01 | | 121.45 | | 120.05 | |
| (parts by wt) | | | | | | | | |
| Plasticizer | 4.21 | | 4.21 | | 4.3 | | 4.21 | |
| (parts by wt) | | | | | | | | |
| Surfactant | PS20 | | BRIJ L23 | | PEG-DME | | PEG-PPG | |
| (parts by wt) | 0.42 | | 0.44 | | 0.44 | | Mw 2200 | |
| | | | | | | | 0.43 | |
| PEOX | 60 | | 60 | | 60.01 | | 60 | |
| (parts by wt) | | | | | | | | |
| CA Flake | 25.05 | | 25.05 | | 25.03 | | 25.03 | |
| (parts by wt) | | | | | | | | |
| % PEOX | 28.62 | | 28.60 | | 28.56 | | 28.62 | |
| % Surfactant | 1.01 | | 1.06 | | 1.06 | | 1.03 | |
| Condensation | 50 s | 60 s | 80 s | 85 s | 100 s | 90 s | 60 s | 60 s |
| Time | | | | | | | | |
| | Example | | | | | | | |
| | 40 | | 41 | | 42 | | 43 | |
| Acetone | 120.02 | | 120.02 | | 120.03 | | 120.11 | |
| (parts by wt) | | | | | | | | |
| Plasticizer | 4.23 | | 4.23 | | 4.28 | | 4.38 | |
| (parts by wt) | | | | | | | | |
| Surfactant | PEG-PPG | | PolyFox | | PolyFox | | Triton | |
| (parts by wt) | Mw | | PF-151N | | PF-156A | | X-100 | |
| | 4400 | | 0.42 | | 0.44 | | 0.43 | |
| | 0.45 | | | | | | | |
| PEOX | 60.04 | | 72.1 | | 60.56 | | 60.02 | |
| (parts by wt) | | | | | | | | |
| CA Flake | 25.12 | | 25 | | 25.02 | | 25.05 | |
| (parts by wt) | | | | | | | | |
| % PEOX | 28.55 | | 2.53 | | 28.76 | | 28.50 | |
| % Surfactant | 1.08 | | 0.96 | | 1.05 | | 1.03 | |
| Condensation | 60 s | 75 s | 90 s | 75 s | 210 s | 270 s | 85 s | 75 s |
| Time | | | | | | | | |

### Examples 44-52: Single Layer Films

Examples 44-48 were prepared similar to the formulations and films of Example 1, but incorporating various amounts of plasticizer, cellulose acetate, and PEOX, for single layer film formulations. Each of the film formulations was prepared with various weight percentages of triacetin as the plasticizer and polysorbate 20 as the surfactant. The formulations of the films are provided in Table 12 along with the film thickness for each film. All the film formulations also included 0.3 parts by weight stearic acid as an anti-blocking agent and 0.07 parts by weight silica. All percentages are weight percentages based on the dry (solvent free) films. The resulting films were qualitatively observed in terms of appearance/clarity and anti-condensation performance of the films were tested using the experimental procedure described below.

TABLE 12
Film Formulations

| | Example | | | | |
|---|---|---|---|---|---|
| | 44 | 45 | 46 | 47 | 48 |
| Film Thickness | 126 | 140 | 136 | 112 | 114 |
| (μm) | | | | | |
| Triacetin | 15.40 | 20.70 | 20.50 | 20.00 | 22.40 |
| (parts by wt) | | | | | |
| PEOX | 13.44 | 24.61 | 18.81 | 8.84 | 6.22 |
| (parts by wt) | | | | | |
| CA Flake | 70.04 | 53.32 | 59.32 | 69.79 | 70.01 |
| (parts by wt) | | | | | |
| Polysorbate 20 | .75 | 1.00 | 1.00 | 1.00 | 1.00 |
| (parts by wt) | | | | | |
| Stearic Acid | .30 | .30 | .30 | .30 | .30 |
| (parts by wt) | | | | | |
| Silica | .07 | .07 | .07 | .07 | .07 |
| (parts by wt) | | | | | |

Examples 49-52 were prepared similar to the formulations and films of Examples 44-48, but having no plasticizer and various amounts of cellulose acetate and PEOX for single layer film formulations. The formulations of the films are provided in Table 13 along with the film thickness for each film.

TABLE 13
Film Formulations with no Plasticizer

Example

| | 49 | 50 | 51 | 52 |
|---|---|---|---|---|
| Film Thickness | 75 | 75 | 65 | 75 |
| (μm) | | | | |
| Plasticizer | 0 | 0 | 0 | 0 |
| (parts by wt) | | | | |
| PEOX | 17.00 | 21.00 | 21.00 | 24.00 |
| (parts by wt) | | | | |
| CA Flake | 81.63 | 78.63 | 77.63 | 74.63 |
| (parts by wt) | | | | |
| Polysorbate 20 | 1.00 | 0.00 | 1.00 | 1.00 |
| (parts by wt) | | | | |
| Stearic Acid | .30 | .30 | .30 | .30 |
| (parts by wt) | | | | |
| Silica | .07 | .07 | .07 | .07 |
| (parts by wt) | | | | |

Laminate

The single layer films of Examples 44-46 were laminated to a core layer. The films were laminated to the core layer in a solvent cast film process. Each of the core layers had a thickness of 120 μm. The core layer included 85.13 parts by weight cellulose acetate flake, 14.50 parts by weight triacetin, 0.3 parts by weight stearic acid, and 0.07 parts by weight silica. The film formulations of Examples 44-46 were laminated to the core layer to form three separate laminates shown in Table 14. The laminates are provided in Table 14 along with the total thickness for each laminate.

TABLE 14

| Example | Laminate | Thickness (μm) |
|---|---|---|
| 53 | Core Layer laminated to | 250 |
| | Example 44 | |
| 54 | Core Layer laminated to | 275 |
| | Example 45 | |
| 55 | Core Layer laminated to | 260 |
| | Example 46 | |

Testing of the Anti-Condensation Compositions

The fog performance of the laminate of Example 54 was tested. To determine initial fog and clear time, deionized water was placed in a 250 ml conical Erlenmeyer flask until the level reached 6 cm from the top. The flask was placed on a hotplate and heated to a temperature of 50° C. Laminates were individually placed on top of the beaker and a stop watch was started. A torch light was aimed at the sample at an angle of 45°. The stop watch was stopped when the first sign of fog was visible, and the result was recorded. The results of the fog tests are shown in Table 15.

TABLE 15

| | Band | Clear | Length | |
|---|---|---|---|---|
| | Initial Fog | Time | of Test | Band |
| Example | (s) | (s) | (s) | Observations |
| 54 | 0 | 300 | 300 | Clear |
| 54 | 0 | 300 | 300 | Clear |
| 54 | 0 | 300 | 300 | Clear |
| 54 | 0 | >240 | 390 | Clear |
| 54 | 0 | 300 | 300 | Clear |

The fog performance of Examples 49-52 was tested according to the same method described in Table 15, but at ambient conditions of 52.1% relative humidity and a temperature of 22° C. The fog testing results of Examples 49-52 exhibit the criticality of the PEOX weight percent in the film composition. In these examples, it was surprisingly and unexpectedly observed that as the amount of PEOX increased, with roughly the same film thickness, the condensation time also increased. For example, the condensation time for a composition including 17 wt % of the oxazoline polymer increased from an average of 55 seconds and 46 seconds on the band side and on the air side, respectively, to greater than an average of 240 seconds and 88 seconds on the band side and the air side, respectively, when the amount of the oxazoline polymer increased from 17 wt % to 24 wt %. In general, condensation time increased with a higher weight percent of the oxazoline polymer in the film composition.

TABLE 16

| | | BAND | AIR | | | | | | | | |
|---|---|---|---|---|---|---|---|---|---|---|---|
| | | SIDE | SIDE | | | | | | | | |
| | | Initial | Initial | Band Side (s) | | | | Air Side (s) | | | |
| | Gauge | Fog | Fog | Trial | Trial | Trial | | Trial | Trial | Trial | |
| Example | (μm) | (s) | (s) | 1 | 2 | 3 | Avg. | 1 | 2 | 3 | Avg. |
| 49 | 70-80 | 1 | 1 | 44 | 51 | 71 | 55 | 46 | 49 | 42 | 46 |
| 50 | 70-80 | 1 | 1 | 75 | 52 | 44 | 57 | 65 | 62 | 53 | 60 |
| 51 | 60-70 | 2 | 2 | 49 | >240 | 121 | 137* | 74 | 128 | >240 | 147* |
| 52 | 70-80 | 2 | 1 | >240 | >240 | >240 | >240 | 52 | 111 | 100 | 88 |

*Average includes the lowest approximation value.

The fog performance of the laminate of Example 54 and the unlaminated film formulation of Example 45 was tested at various times after casting. The time after casting represents the time of testing after each of the films and laminates were formed. The fog performance of Examples 45 and 54 were tested according to the same method described in Table 15. As shown in Table 17, the performance of the laminated and unlaminated film deteriorated over time when triacetin was used as the plasticizer. Subsequent testing indicated that triacetin appears to have a high tendency to migrate out of the film or laminate comprising PEOX upon contact with water.

TABLE 17

| | | Band | Air | | | Time | | | |
|---|---|---|---|---|---|---|---|---|---|
| | Gauge | Initial | Initial | Band | Air | after | | Band | Air |
| Example | (μm) | Fog (s) | Fog (s) | Observations | Observations | casting | | (s) | (s) |
| 45 | 140 | 1 | 8 | Clear | Clear | 2 | days | >120 | >60 |
| 45 | 140 | 14 | 22 | Clear | Clear | 21 | days | >300 | >300 |
| 45 | 140 | 12 | 7 | Clear | Clear | 1 | month | >300 | >300 |
| 45 | 140 | 24 | 30 | Clear | Clear stored | 4 | months | 240 | >300 |
| | | | | | in roll | | | | |
| 54 | 270 | 6 | | Clear | | 3 | days | >180 | N/A |
| 54 | 270 | 25 | | Clear | | 7 | days | 210 | N/A |
| 54 | 270 | 35 | | Clear | | 21 | days | >300 | N/A |
| 54 | 270 | 15 | | Clear | Stored in | 1 | month | 240 | N/A |
| | | | | | roll | | | | |
| 54 | 270 | 41 | | Clear | | 2 | months | 260 | N/A |
| 54 | 270 | 38 | | Clear | | 4 | months | 240 | N/A |

### Examples 45 and 54: Mechanical Properties

The physical properties of the unlaminated film of Example 45 and the laminated film of Example 54 were tested. The laminated film of Example 54 exhibited a decrease in stress peak compared to the unlaminated film. The physical properties of Examples 45 and 54 are shown in Table 18. In both the unlaminated and laminated film, the plasticizer was triacetin. The Young's Modulus of the single layer film decreased when it was laminated to a core comprising triacetin as the plasticizer.

TABLE 18

| | | Elong | | Stress | | Young's | | Elongation at | |
|---|---|---|---|---|---|---|---|---|---|
| | PEOX | % | | Peak | | Modulus | | Yield | |
| Example | % | MD | TD | MD | TD | MD | TD | MD | TD |
| 45 | 24.61 | 20 | 47 | 69.44 | 55 | 1980 | 1659 | 4.56 | 4.68 |
| 54 | 24.61 | 20 | 37 | 50.9 | 56 | 1650 | 1493 | 5.06 | 4.97 |

Examples 56 and 57 were prepared similar to the formulations and films of Examples 44-48, but with no plasticizer or surfactant. The formulation of the films are provided in Table 19 along with the film thickness for each film. All the film formulations also included 0.3 parts by weight stearic acid as an anti-blocking agent and 0.07 parts by weight silica. All percentages are weight percentages based on the dry (solvent free) films.

TABLE 19
Film Formulations

Example

| | 56 | 57 |
|---|---|---|
| Film Thickness | 131 | 125 |
| (μm) | | |
| Triacetin | 0 | 0 |
| (parts by wt) | | |
| PEOX | 26.8 | 25 |
| (parts by wt) | | |
| CA Flake | 72.83 | 74.63 |
| (parts by wt) | | |
| Polysorbate 20 | 0 | 0 |
| (parts by wt) | | |
| Stearic Acid | 0.3 | 0.3 |
| (parts by wt) | | |
| Silica | 0.07 | 0.07 |
| (parts by wt) | | |

The tensile properties of the films were measured in accordance with ASTM D882-12 (2012) and the tear properties were measured in accordance with ASTM D1938-14 (2014), and are shown in Table 20. In each of the Examples, the Young's Modulus was very high indicating that the single layer films were very stiff. The physical properties of Examples 56 and 57 are shown in Table 20.

TABLE 20

| | | | TEAR | | TEAR | | Elong | | Stress | | Young's | | Elongation | |
|---|---|---|---|---|---|---|---|---|---|---|---|---|---|---|
| | Gauge | | TD | | MD | | % | | Peak | | Modulus | | at Yield | |
| | (μm) | MW | Max | Ave | Max | Ave | MD | TD | MD | TD | MD | TD | MD | TD |
| 56 | 131 | 500 | 0.254 | 0.237 | 0.271 | 0.214 | 18 | 13 | 104.13 | 113.16 | 4493 | 4729 | 4.6 | 4.95 |
| 57 | 125 | 500 | 0.23 | 0.224 | 0.237 | 0.217 | 15 | 18 | 95.21 | 94.13 | 4347.5 | 4207.8 | 4.6 | 4.51 |

Due to the stiffness of the single layer films comprising PEOX, lamination to an inner core of more pliable material is preferred. However, PEOX has negative interactions with certain additives, e.g., triacetin, causing migration of these additives from the laminate over time. This negatively impacts the anti-condensation performance of the laminate. In other words, PEOX may decrease the stability of additives other than cellulose acetate. But, when the PEOX layer is laminated to a phosphate plasticizer, e.g., tris(chloroisopropyl)phosphate, a non-interacting core, additives did not migrate from the laminate and maintained good anti-condensation performance.

The formulations of Examples 56 and 57 exhibited very good fog performance. The fog performance of the Examples are shown in Table 21.

TABLE 21

| | | Initial | | Fog free | | Fog | |
|---|---|---|---|---|---|---|---|
| | | Fog (s) | | time (s) | | time (s) | |
| Example | Gauge | Band | Air | Band | Air | Band | Air |
| 56 | 132 | 10 | 10 | >300 | >300 | >300 | >300 |
| 57 | 125 | 20 | 20 | >300 | >300 | >300 | >300 |

Initially, Examples 56 and 57 exhibited very good fog performance when tested shortly after casting. Over time, however, the fog performance of each of these examples decreased due to the migration of the plasticizer.

The weight loss of films comprising various amounts of PEOX with different plasticizers were measured in Table 22. After casting, the films were placed in a water bath for 24 hours to measure weight loss when the films interacted with water. Three different films for each example were tested and the average weight loss was measured. The weight loss for the controls for each film were measured at ambient temperature at atmosphere. The percent weight loss is based on the total weight of the films.

Table 22 shows the anti-condensation performance of the films deteriorated over time when used with certain plasticizers. For example, the films had a greater weight loss when triacetin or triethyl citrate were used as plasticizers. As shown in Table 22, triacetin, triethyl citrate, and diethyl phthalate appear to have a high tendency to migrate out of a film comprising PEOX. Specifically, Examples 63, 64, 68-71, and 74 had a weight loss greater than 10%. Films including a higher weight percent of PEOX exhibited a greater weight loss when triacetin was used as the plasticizer.

TABLE 22

| | | | Weight Loss | | | | | | |
|---|---|---|---|---|---|---|---|---|---|
| | % PEOX | | % Plasticizer | Controls | | Weight Change % | | | |
| Examples | in films | Plasticizer | in films | C1 | C2 | 1 | 2 | 3 | Avg. |
| 59 | 28 | TEC | 14 | −0.4 | −0.1 | −10.6 | −9.6 | −11.5 | −10.6 |
| 60 | 14 | TRI | 17 | −0.2 | 0 | −7 | −6.7 | −8.4 | −7.4 |
| 61 | 28 | DEP | 14 | −0.1 | −0.1 | −8.7 | −7.5 | −10.8 | −9.0 |
| 62 | 28 | TCPP | 14 | −1.9 | −0.2 | −2.2 | −2.3 | −2.7 | −2.4 |
| 63 | 28 | TRI/KET | 7/7 | −4.3 | | −12.2 | −11.8 | −12.3 | −12.1 |
| 64 | 21 | TRI | 17 | −0.1 | −0.1 | −11.2 | −9.5 | −12.5 | −11.1 |
| 65 | 28 | TCPP | 14 | −0.3 | −0.3 | −1.3 | −1.4 | −1.5 | −1.4 |
| 66 | 28 | TEC | 14 | −0.1 | −2.4 | −10.7 | −10.9 | −12 | −11.2 |
| 67 | 28 | N/A | N/A | −0.4 | −0.3 | −1.8 | −1.7 | −3.6 | −2.4 |
| 68 | 28 | DEP/TRI | 2/12 | −0.5 | −0.1 | −10.7 | −11.1 | −10.6 | −10.8 |
| 69 | 28 | DEP/TRI | 3/12 | −0.5 | −0.6 | −12.4 | −12.5 | −12.4 | −12.4 |
| 70 | 28 | DEP/TRI | 4/12 | −0.1 | 0.2 | −15.1 | −9.6 | −10.3 | −11.7 |
| 71 | 24 | DEP/TRI | 2.5/11.5 | −0.3 | −0.1 | −11.4 | −9.1 | −10.7 | −10.4 |
| 72 | 10 | TRI | 14 | −0.2 | −0.4 | −3.1 | −3.7 | −3.3 | −3.4 |
| 73 | 6 | TRI | 14 | −0.6 | −0.1 | −4.6 | −4.5 | −4.2 | −4.4 |
| 74 | 28 | TRI | 14 | 0.1 | −0.1 | −11.6 | −11.6 | −12 | −11.7 |
| Example | 24.61 | TRI | 20.7 | 0 | 0.2 | −4.2 | −2.4 | −3 | −3.2 |
| 54 | | | | | | | | | |
| Example | 24.61 | TRI | 20.7 | 0.1 | 0 | −9.9 | −7.9 | −9.2 | −9.0 |
| 45 | | | | | | | | | |

Surprisingly, when the films include a phosphate plasticizer, e.g., TCPP, the average weight loss was almost negligible. In particular, Example 65 had a weight loss of less than 2%, e.g., 1.4%. Thus, lamination of the anti-condensation layer including PEOX to a core layer including tris(chloroisopropyl)phosphate provided a more stable high performance material with desirable anti-condensation properties. In fact, films that included TCPP as the plasticizer had almost the same weight loss as Example 67, which included no plasticizer. It is contemplated that a PEOX film laminated to a core layer comprising TCPP as the plasticizer has a lower weight loss than a PEOX film laminated to a non-phosphate plasticizer.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to other embodiments may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. An anti-condensation composition, comprising a cellulosic material selected from cellulose, a cellulose ester, a cellulose ether, an ether cellulose ester, nitrocellulose, and mixtures thereof, and a polymer of an oxazoline having an average molecular weight greater than 50,000 daltons.

2. The anti-condensation composition of claim 1, wherein the polymer comprises poly(2-ethyl-2-oxazoline) having a monomer structure of formula (I): 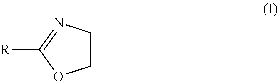
wherein R is hydrogen, an alkyl group, a carboxyl group, a hydroxyl group or an ether group.

3. The anti-condensation composition of claim 1, wherein the polymer is soluble in acetone.

4. The anti-condensation composition of claim 1, wherein the polymer has a molecular weight from 200,000 to 1,000,000 daltons, and the composition comprises the polymer in an amount from 2 to 40 wt. %, based on the total weight of the composition.

5. The anti-condensation composition of claim 1, wherein the polymer has a molecular weight from 60,000 to 600,000 daltons, and the composition comprises the polymer in an amount from 18 to 28 wt. %, based on the total weight of the composition.

6. The anti-condensation composition of claim 1, wherein the polymer has a molecular weight from 200,000 to 800,000 daltons, and the composition comprises the polymer in an amount from 10 to 40 wt. %, based on the total weight of the composition, and the composition has a condensation time greater than 10 seconds and a haze value ranging from 0.01% to 4%.

7. The anti-condensation composition of claim 1, wherein the polymer has a molecular weight from 400,000 to 600,000 daltons, and the composition comprises the polymer in an amount from 18 to 28 wt. %, based on the total weight of the composition, and the composition has a condensation time ranging from 30 to 90 seconds and a haze value less than 1%.

8. The anti-condensation composition of claim 1, wherein the composition comprises the polymer in an amount from 28 to 34 wt. %, a surfactant in an amount from 0 to 2 wt %, and a plasticizer in an amount from 0 to 5 wt %, based on the total weight of the composition, wherein the condensation time is greater than or equal to 2 minutes.

9. The anti-condensation composition of claim 1, wherein the composition comprises the polymer in an amount from 28 to 33 wt. %, a surfactant in an amount from 1 to 1.5 wt %, and a plasticizer in an amount from 4 to 5 wt %, wherein the condensation time is greater than 5 minutes.

10. The anti-condensation composition of claim 1, wherein the composition has a thickness from 13 to 30 microns, wherein the polymer has a molecular weight from 50,000 to 500,000 daltons, and the composition has a condensation time from 55 to 108 seconds.

11. The anti-condensation composition of claim 1, wherein the composition has a thickness from 17 to 18 microns, wherein the polymer has a molecular weight from 200,000 to 500,000 daltons, and the composition has a condensation time from 55 to 74 seconds.

12. The anti-condensation composition of claim 1, wherein the composition has a thickness from 100 to 300 microns, wherein the composition comprises the polymer in an amount from 18 to 28 wt. % and propylene carbonate in an amount from 5 to 14 wt %, based on the total weight of the composition, wherein the polymer has a molecular weight from 200,000 to 500,000 daltons, wherein a pencil hardness of the composition is from 5B to 2H.

13. The anti-condensation composition of claim 12, wherein the composition has a tensile strength from 65 Nmm⁻² to 100 Nmm⁻², an elongation from 10% to 50%, and a Young's modulus from 1800 Nmm⁻² to 3500 Nmm⁻².

14. The anti-condensation composition of claim 12, having a condensation time greater than 90 seconds.

15. The anti-condensation composition of claim 12, having a haze value from 0.1% to 0.3%.

16. The anti-condensation composition of claim 1, wherein the composition has a thickness from 230 to 250 microns, wherein the composition comprises the polymer in an amount from 18 to 23 wt. % and propylene carbonate in an amount from 5 to 14 wt %, based on the total weight of the composition, wherein the polymer has a molecular weight of 400,000 to 600,000 daltons, wherein a pencil hardness of the composition is from H to 2H.

17. The anti-condensation composition of claim 16, wherein the composition has a tensile strength from 67 Nmm⁻² to 82 Nmm⁻², an elongation from 28% to 40%, and a Young's modulus from 2150 Nmm⁻² to 2500 Nmm⁻².

18. The anti-condensation composition of claim 16, having a condensation time greater than 90 seconds.

19. The anti-condensation composition of claim 16, having a haze value ranging from 0.13% to 0.3%.

20. The anti-condensation composition of claim 1, further comprising a plasticizer in an amount from 3 to 30 wt. %, based on the total weight of the composition, wherein the plasticizer is selected from the group consisting of 1,2,3-triacetoxypropane (triacetin), trimethyl phosphate, triethyl phosphate, tributyl phosphate, triphenyl phosphate, triethyl citrate, acetyl trimethyl citrate, acetyl triethyl citrate, acetyl tributyl citrate, dibutyl phthalate, diaryl phthalate, diethyl phthalate, dimethyl phthalate, di-2-methoxyethyl phthalate, di-octyl phthalate (and isomers), dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, aromatic diol, substituted aromatic diols, aromatic ethers, tripropionin, polycaprolactone, glycerin, glycerin esters, diacetin, polyethylene glycol, polyethylene glycol esters, polyethylene glycol diesters, di-2-ethylhexyl polyethylene glycol ester, diethylene glycol, polypropylene glycol, polyglycoldiglycidyl ethers, dimethyl sulfoxide, N-methyl pyrollidinone, C₁-C₂₀ diacid esters, dimethyl adipate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkylphosphate esters, phospholipids, ethylene carbonate, propylene carbonate, trimethylene carbonate, and mixtures thereof.

21. The anti-condensation composition of claim 1, further comprising at least one of a surfactant, a plasticizer, a lubricant, a crosslinking agent, a coloring agent, and a hydrophilic agent.

22. The anti-condensation composition of claim 1, further comprising a surfactant present in an amount from 0.1 to 3 wt. %, based on the total weight of the composition, wherein the surfactant is selected from the group consisting of a sorbitan ester, an ethoxylated sorbitan ester, ethoxylate surfactants, fatty alcohol ethoxylates, alkyl phenols ethoxylate, a fluorosurfactant, a nonionic surfactant, an anionic surfactant, a cationic surfactant, and mixtures thereof.

23. The anti-condensation composition of claim 22, wherein the surfactant is an anionic fluorosurfactant.

24. The anti-condensation composition of claim 1, having a thickness from 5 microns to 4000 microns.

25. The anti-condensation composition of claim 1, wherein the composition is unsaponified.

26. A consumer product having a surface and comprising an anti-condensation composition disposed on said surface as a film,
wherein the anti-condensation composition comprises a cellulosic material selected from cellulose, a cellulose ester, a cellulose ether, an ether cellulose ester, nitrocellulose, and mixtures thereof, and a polymer of an oxazoline having an average molecular weight greater than 50,000 daltons.

27. The consumer product of claim 26, wherein the anti-condensation composition has a pencil hardness value greater than F.

28. A process for producing an anti-condensation composition, the process comprising the steps of:
(a) combining a solvent; a cellulosic material selected from cellulose, a cellulose ester, a cellulose ether, an ether cellulose ester, nitrocellulose, and mixtures thereof; and a polymer of an oxazoline having an average molecular weight greater than 50,000 daltons, to form a dope; and
(b) casting the dope to form the anti-condensation composition.

29. The process of claim 28, wherein the combining in step (a) comprises combining a solvent, a cellulosic material selected from cellulose, a cellulose ester, a cellulose ether, an ether cellulose ester, nitrocellulose, and mixtures thereof; a polymer of an oxazoline having an average molecular weight greater than 50,000 daltons; and at least one of a plasticizer and a surfactant.

30. The process of claim 28, wherein the dope comprises the solvent in an amount from 70 to 80 wt. %, the cellulosic material in an amount from 5 to 15 wt. %, the polymer in an amount from 1 to 10 wt. %, and the plasticizer in an amount from 0.1 to 5 wt. %.

31. The process of claim 28, wherein the solvent comprises acetone.

32. A laminate comprising:
an anti-condensation layer comprising a cellulosic material selected from cellulose, a cellulose ester, a cellulose ether, an ether cellulose ester, nitrocellulose, and mixtures thereof, and a polymer of an oxazoline having an average molecular weight greater than 50,000 daltons; and
a core layer adhered to the anti-condensation layer.

33. The laminate of claim 32, wherein the laminate comprises two anti-condensation layers and the core layer is sandwiched between the two anti-condensation layers.

34. The laminate of claim 32, wherein the polymer comprises poly(2-ethyl-2-oxazoline) having a monomer structure of formula (I): 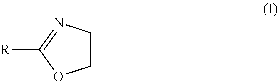
wherein R is hydrogen, an alkyl group, a carboxyl group, a hydroxyl group or an ether group.

35. The laminate of claim 32, wherein the composition comprises the polymer in an amount from 2 to 40 wt. %, based on the total weight of the composition, wherein the polymer has a molecular weight from 200,000 to 1,000,000 daltons.

36. The laminate of claim 32, wherein the anti-condensation composition comprises the polymer in an amount from 10 to 40 wt. %, based on the total weight of the anti-condensation composition, wherein the polymer has a molecular weight from 200,000 to 800,000 daltons, and the anti-condensation composition having a condensation time greater than 10 seconds and a haze value ranging from 0.01% to 4%.

37. The laminate of claim 32, wherein the anti-condensation layer further comprises a surfactant present in an amount from 0.1 to 3 wt. %, based on the total weight of the composition, wherein the surfactant is selected from the group consisting of a sorbitan ester, an ethoxylated sorbitan ester, ethoxylate surfactants, fatty alcohol ethoxylates, alkyl phenols ethoxylate, a fluorosurfactant, a nonionic surfactant, an anionic surfactant, an anionic fluorosurfactant, and a cationic surfactant.

38. The laminate of claim 32, wherein the core layer comprises cellulose acetate and a plasticizer, wherein the plasticizer comprises a low water-solubility plasticizer selected from the group consisting of phosphate plasticizers, acetyl trimethyl cictrate, acetyl triethyl citrate, acetyl tributyl citrate, dimethyl sebacate, di-n-butyl sebacate, dioctyl sebacate, diisodecyl adipate, dibutoxylethyl adipate, dibutoxyethoxylethyl sebacate, dibutyl phthalate, diaryl phthalate, dethyl phthalate, di-octyl phthalate (and isomers), di-n-heptyl phthalate, di-2-ethylhexyl phthalate, diisononyl phthalate, diisodecyl phthalate, diundecyl phthalate, tri-2-ethylhexyl trimellitate, tri-(7C-9C(linear)) trimellitate, dibutyl tartrate, polyethylene glycol diesters, epoxidized soy bean oil, castor oil, linseed oil, expoxidized linseed oil, other vegetable oils, polymeric polyester plasticizers, and combinations thereof.

39. The laminate of claim 38, wherein the phosphate plasticizer is selected from the group consisting of tris(chloroisopropyl)phosphate, trimethyl phosphate, triethyl phosphate, tributyl phosphate, triphenyl phosphate, tri cresyl phosphate (such as Trade name TCP-100, TCP-40), tris(dichloropropyl) phosphate, tri-(2-ethylhexyl) phosphate, triisopropyl phenyl phosphate, alkyl diaryl phosphates such as 2-ethylhexyl diphenyl phosphate, isodecyl diphenyl phosphate, tributoxyethyl phosphate, butylphenyl diphenyl phosphate, cresyl diphenyl phosphate, isopropylphenyl diphenyl phosphate, diphenyl octyl phosphate, trixylenyl phosphate, and combinations thereof.

40. The laminate of claim 38, wherein the core layer comprises tris(chloroisopropyl)phosphate in an amount from 10 to 20 wt. % and cellulose acetate in an amount from 80 to 90 wt. %, based on the total weight of the core layer.

41. The laminate of claim 32, wherein the anti-condensation layer comprises the polymer in an amount from 10 to 30 wt. % and cellulose acetate in an amount from 70 to 90 wt. %, based on the total weight of the anti-condensation layer.

42. The laminate of 41, wherein a condensation time is greater than 240 seconds.

43. The laminate of claim 32, wherein the anti-condensation layer is extruded or coated onto the core layer.
